(19) United States
(12) Patent Application Publication
(10) Pub. No.: US 2003/0018789 A1
(43) Pub. Date: Jan. 23, 2003

(54) Information providing method and information providing system and terminal therefor

(75) Inventor: Yoshihide Ishiguro, Tokyo (JP)

Correspondence Address: FOLEY AND LARDNER, SUITE 500, 3000 K STREET NW, WASHINGTON, DC, 20007, US

(73) Assignee: NEC CORPORATION

(21) Appl. No.: 10/180,025

(22) Filed: Jun. 27, 2002

(30) Foreign Application Priority Data
Jun. 27, 2001 (JP) 2001-193856

(51) Int. Cl. G06F 15/16

(52) U.S. Cl. 709/228

(57) ABSTRACT

An information providing system permits user to efficiently obtain information retrieved and accessed at an office or a home, later in mobile environment with troubling the user, at an occasion where the information is indeed necessary. An information provides to a user by issuing retrieval demand to an information providing apparatus. In the information providing apparatus, a retrieval demand is received and information retrieval is performed according to the retrieval condition contained in the retrieval demand to obtain information retrieval result. Also, a history retrieval of the stored retrieval history information is also performed according to the user ID of the user terminals and the retrieval condition contained in the retrieval demand. The retrieval result is transmitted to be displayed of the user terminal.

### BACKGROUND OF THE INVENTION

1. Field of the Invention

The present invention relates generally to an information providing method and an information providing system and a terminal to be used for implementing the information providing method. More particularly, the invention relates to an information providing system for retrieving a document database and so forth and providing information to a user in response to an information providing demand from a moving user.

2. Description of the Related Art

Owing to wide spreading of the Internet in general public society, a large number of websites are providing services for enabling retrieval of desired pages on the Internet by a user input of a desired keyword. Such service is typically referred to as WWW (World Wide Web) search engine, as represented by Alta Vista (http://www.altavista.com), Google (http://www.google.com). The user may obtain information of relevant WWW pages presenting on the Internet by establishing connection with such site and inputting a desired keyword.

Here, when the obtained information is information to be required again in the future, such as information of destination to trip, shops to visit, for example, it becomes necessary to once record the obtained information for permitting making reference to the information at an appropriate timing. In browser software, such as the Internet Explorer (trademark) of Microsoft, Netscape Navigator (trademark) of AOL, by functions called “favorite site” or “bookmark”, the function to maintain address of once visited web pages for permitting subsequent easy access of such web pages, is realized.

On the other hand, at BLINK (http//blink.co.jp/), on-line bookmark service to permit on-line access to personal bookmark information, is provided. By such service, user's bookmark information can be accessed from anywhere by the user without any restriction of browser. On the other hand, by utilizing applications similar to scheduler running on an electronic databook, personal digital assistance and so forth, it is possible to receive information input in the past at a date and time (timing) desired by the user. Namely, by preliminarily registering the information desired to be notified and desired date and time on a calendar, the user may obtain the information desired to receive at a desired timing.

Also, by utilizing a mobile terminal mounting a navigation system or GPS (Global Positioning System), notice of information can be received with taking a user position as a key of timing instead of the date and time. In this case, by preliminarily registering information content desired to receive and the position on a map desired to receive the information content, the user may receive the desired information at the desired position.

On the other hand, in Japanese Unexamined Patent Publication No. Heisei 10(1998)-105453, a history of data demand from a client is stored in a repeating installation separate from the client or server to permit a plurality of clients to access historical information concerning data demand in the past. Namely, address information of data as data demand from the user and date and time, on which the data is obtained are stored in the repeating installation located between the client and the server so that the desired data can be obtained later by designating address of data and date and time from the client. In the information to be held as history, user name and project name designated by the user may be included as well as the address and date and time, and can be designated as condition for obtaining data later.

As set forth above, information obtained from retrieval of WWW or database, particularly in the case of information relating to place or shop existing in the real world, becomes important when the user is in the site near the recorded place in the real world away from the terminal in the office or home. Therefore, even when the information is stored and maintained, it should be merely wasting unless the information can be accessed as needed in the real world.

Namely, it is desired to permit the user to access the information obtained in an environment of office or home from mobile environment outside of office and home without troubling the user and at timing where the information is needed.

However, in case of the foregoing bookmark system, while means for temporarily recording the information required by the user is provided, it is not possible to efficiently access the information recorded in the past at timing where the information is required, particularly in mobile environment. Namely, the user us required to find information recorded in the past and currently required from the local terminal or on-line bookmark.

On the other hand, when the scheduler on the personal digital assistance or the navigation system, the user may obtain the information at the desired timing. However, for enjoying the benefit, the user is required to register the information content desired to be notified, and timing or site. This can be done by manual input. In the alternative, it is also possible to download the corresponding information from a network to the terminal, utilizing a flash memory card or the like. Nevertheless, the user may be required complicated operation for receiving such service.

A problem encountered in the foregoing technologies is that the information obtained in the office, home or the like cannot be obtained simply by a mobile environment outside of the office, home or the like, as required.

Furthermore, in the method disclosed in Japanese Unexamined Patent Publication No. Heisei 10-105453, it is possible to store the information obtained in the office or home history and obtain the historical information at the visited site. However, the information held as history is user name, URL (Uniform Resource Locator), project name and time information. In order to obtain the desired information, while unspecified designation of time or elimination of a part of information is possible, it is required designate these values by the user. Particularly, in the mobile environment, such as in the visited site, it is difficult to designate data at every occasion of obtaining data to be a burden for the user. This problem is caused for lacking of mechanism to autonomously retrieving information which may be necessary in the condition where the user is situated, from the information stored in the history.

Namely, by utilizing simply keyword input by the user or position information, information retrieval and obtaining in the office or home environment and mobile environment has to be linked with each other without loading burden for the user.

### SUMMARY OF THE INVENTION

The present invention has been worked out in view of the problems set forth above. It is therefore an object of the present invention to provide an information providing system, an information providing method and an information providing apparatus, which permits user to efficiently obtain information retrieved and accessed at an office or a home, later in mobile environment without troubling the user, at an occasion where the information is indeed necessary.

According to the first aspect of the present invention, an information providing method providing information to a user by issuing retrieval demand to an information providing apparatus from a user terminal through a network, comprises the steps of:

in the information providing apparatus, storing at least a user ID, a past retrieval condition, a past information retrieval result as a retrieval history information relating to a past retrieval demand from the user terminal;

in the user terminal, transmitting a retrieval demand including the retrieval condition to the information providing apparatus;

in the information providing apparatus, receiving the retrieval demand and performing information retrieval according to the retrieval condition contained in the retrieval demand to obtain information retrieval result;

performing history retrieval of the stored retrieval history information according to the user ID of the user terminals and the retrieval condition contained in the retrieval demand;

transmitting retrieval result information contained in the past information retrieval result contained in the retrieval history information and the information retrieval result to the user terminal; and

in the user terminal, receiving and displaying the retrieval result information.

According to the second aspect of the present invention, an information providing method for issuing retrieval demand to an information providing apparatus from a user terminal through a network and providing information to a user, comprises the steps of:

in the information providing apparatus, storing at least a user ID, a past retrieval condition, a past information retrieval result as a retrieval history information relating to a past retrieval demand from the user terminal;

in the user terminal, transmitting a retrieval demand including the retrieval condition to the information providing apparatus;

in the information providing apparatus, receiving the retrieval demand and performing information retrieval according to the retrieval condition contained in the retrieval demand to obtain information retrieval result;

performing history retrieval of the stored retrieval history information according to the user ID of the user terminals and the information retrieval result obtained through information retrieval for obtaining the corresponding retrieval history information;

transmitting retrieval result information contained in the past information retrieval result contained in the retrieval history information and the information retrieval result to the user terminal; and

in the user terminal, receiving and displaying the retrieval result information.

According to the third aspect of the present invention an information providing method for issuing retrieval demand to an information providing apparatus from a user terminal through a network and providing information to a user, comprises the steps of:

in the information providing apparatus, storing at least a user ID and a past information retrieval result as a retrieval history information relating to a past retrieval demand from the user terminal and extracting position information relating to the past information retrieval result for storing with correspondence to the past information retrieval result;

in the user terminal, transmitting a retrieval demand including the retrieval condition and place information indicative of a current position to the information providing apparatus;

in the information providing apparatus, obtaining information retrieval result by information retrieval according to the retrieval condition contained in the received retrieval demand;

performing history retrieval of the retrieval history information stored according to the user ID of the user terminal and the place information contained in the retrieval demand, and obtaining the retrieval history information containing the position information matching with user ID and corresponding to the place information;

transmitting retrieval result information contained in the past information retrieval result contained in the retrieval history information and the information retrieval result to the user terminal; and

in the user terminal, receiving and displaying the retrieval result information.

According to the fourth aspect of the present invention, an information providing method for issuing retrieval demand to an information providing apparatus from a user terminal through a network and providing information to a user, comprises the steps of:

in the information providing apparatus, storing at least a user ID and a past information retrieval result as a retrieval history information relating to a past retrieval demand from the user terminal and extracting date and time information relating to the past information retrieval result for storing with correspondence to the past information retrieval result;

in the user terminal, transmitting a retrieval demand including the retrieval condition;

in the information providing apparatus, obtaining information retrieval result by information retrieval according to the retrieval condition contained in the received retrieval demand;

performing history retrieval of the retrieval history information stored according to the user ID of the user terminal and the date and time information contained in the retrieval demand, and obtaining the retrieval history information containing the date and time information matching with user ID and corresponding to the date and time information;

transmitting retrieval result information contained in the past information retrieval result contained in the retrieval history information and the information retrieval result to the user terminal; and

in the user terminal, receiving and displaying the retrieval result information.

According to the fifth aspect of the present invention an information providing apparatus comprises:

storage means for storing at least a user ID, a past retrieval condition, a past information retrieval result as retrieval history information relating to a past retrieval demand from a user terminal;

retrieval control means for receiving a retrieval demand from the user terminal, requesting information retrieval using the retrieval condition contained in the retrieval demand to information retrieving means for performing information retrieval according to the retrieval condition, receiving information retrieval result, and registering the information retrieval result in the storage means together with the retrieval condition, the user ID of the user terminal; and

history retrieval means for performing history retrieval of the retrieval history information stored in the storage means according to the user ID of the user terminal and the retrieval condition contained in the retrieval demand.

According to the sixth aspect of the present invention, an information providing apparatus providing information to a user by issuing a retrieval demand from a user terminal through a network, comprises:

storage means for storing at least a user ID, a past retrieval condition, a past information retrieval result as retrieval history information relating to a past retrieval demand from a user terminal;

retrieval control means for receiving a retrieval demand from the user terminal, requesting information retrieval using the retrieval condition contained in the retrieval demand to information retrieving means for performing information retrieval according to the retrieval condition, receiving information retrieval result, and registering the information retrieval result in the storage means together with the retrieval condition, the user ID of the user terminal; and

history retrieval means for performing history retrieval of the retrieval history information stored in the storage means according to the user ID of the user terminal and the information retrieval result obtained by the information retrieval.

According to the seventh aspect of the present invention, an information providing apparatus comprises:

storage means for storing at least a user ID, a past retrieval condition and a past information retrieval result with correspondence therebetween and storing position information relating to the past information retrieval result with correspondence to the past information retrieval result;

retrieval control means for receiving a retrieval demand containing a retrieval condition and a place information indicative of a current position from the user terminal, requesting information retrieval to information retrieval means for performing information retrieval according to the retrieval condition, using the retrieval condition contained in the retrieval demand, receiving information retrieval result, and registering the information retrieval result in the storage means together with the retrieval condition, the user ID of the user terminal; and

history retrieval means for performing history retrieval of the retrieval history information stored in the storage means according to the user ID of the user terminal and the place information contained in the retrieval demand, for obtaining the retrieval history information matching the user ID and containing position information corresponding to the place information.

According to the eighth aspect of the present invention, an information providing apparatus comprises:

storage means for storing at least a user ID, a past retrieval condition and a past information retrieval result with correspondence therebetween and storing date and time information relating to the past information retrieval result with correspondence to the past information retrieval result;

retrieval control means for receiving a retrieval demand containing a retrieval condition and a place information indicative of a current position from the user terminal, requesting information retrieval to information retrieval means for performing information retrieval according to the retrieval condition, using the retrieval condition contained in the retrieval demand, receiving information retrieval result, and registering the information retrieval result in the storage means together with the retrieval condition, the user ID of the user terminal; and

history retrieval means for performing history retrieval of the retrieval history information stored in the storage means according to the user ID of the user terminal and information of date and time, on which the retrieval demand is issued, for obtaining the retrieval history information matching the user ID and containing date and time information matching the condition with the information of date and time, on which the retrieval demand is issued.

According to the ninth aspect of the present invention, a user terminal receiving information by issuing a retrieval demand to an information providing apparatus through a network, comprises:

means for making the information providing means to store at least a user ID, a past retrieval condition and a past information retrieval result with correspondence therebetween as a retrieval history relating to the past retrieval demand from the user terminal;

means for transmitting the retrieval demand including the retrieval condition to the information providing apparatus;

means for commanding operation of the information providing apparatus for obtaining information retrieval result through information retrieval according to the retrieval condition contained in the retrieval demand, performing history retrieval of the retrieval history information storing according to the user ID and the retrieval condition contained in the retrieval demand for obtaining the corresponding retrieval history information and transmitting the retrieval result information containing the past information retrieval result contained in the retrieval history information and the information retrieval result; and

means for receiving the retrieval result information and display the same.

According to the tenth aspect of the present invention, a user terminal receiving information by issuing a retrieval demand to an information providing apparatus through a network, comprising:

means for making the information providing means to store at least a user ID, a past retrieval condition and a past information retrieval result with correspondence therebetween as a retrieval history relating to the past retrieval demand from the user terminal;

means for transmitting the retrieval demand including the retrieval condition to the information providing apparatus;

means for commanding operation of the information providing apparatus for obtaining information retrieval result through information retrieval according to the retrieval condition contained in the retrieval demand, performing history retrieval of the retrieval history information storing according to the user ID and the information retrieval result obtained by performing information retrieval for obtaining the corresponding retrieval history information and transmitting the retrieval result information containing the past information retrieval result contained in the retrieval history information and the information retrieval result; and

means for receiving the retrieval result information and display the same.

According to the eleventh aspect of the present invention, a user terminal receiving information by issuing a retrieval demand to an information providing apparatus through a network, comprises:

means for making the information providing means to store at least a user ID and a past information retrieval result with correspondence therebetween as a retrieval history relating to the past retrieval demand from the user terminal, and extracting a position information relating to the past information retrieval result to store the position information with correspondence with the past information retrieval result;

means for transmitting the retrieval demand including the retrieval condition and a place information indicative of a current position to the information providing apparatus;

means for commanding operation of the information providing apparatus for obtaining information retrieval result through information retrieval according to the retrieval condition contained in the retrieval demand, performing history retrieval of the retrieval history information storing according to the user ID and the place information contained in the retrieval demand for obtaining the corresponding retrieval history information where the user IDs match and containing position information corresponding to the place information and transmitting the retrieval result information containing the past information retrieval result contained in the retrieval history information and the information retrieval result; and

means for receiving the retrieval result information and display the same.

According to the twelfth aspect of the present invention, a user terminal receiving information by issuing a retrieval demand to an information providing apparatus through a network, comprises:

means for making the information providing means to store at least a user ID and a past information retrieval result with correspondence therebetween as a retrieval history relating to the past retrieval demand from the user terminal, and extracting a date and time information relating to the past information retrieval result to store the position information with correspondence with the past information retrieval result;

means for transmitting the retrieval demand including the retrieval condition to the information providing apparatus;

means for commanding operation of the information providing apparatus for obtaining information retrieval result through information retrieval according to the retrieval condition contained in the retrieval demand, performing history retrieval of the retrieval history information storing according to the user ID and information relating to date and time, on which the retrieval demand is issued for obtaining the corresponding retrieval history information where the user IDs match and containing date and time information corresponding to the place information and transmitting the retrieval result information containing the past information retrieval result contained in the retrieval history information and the information retrieval result; and

means for receiving the retrieval result information and display the same.

### BRIEF DESCRIPTION OF THE DRAWINGS

The present invention will be understood more fully from the detailed description given hereinafter and from the accompanying drawings of the preferred embodiment of the present invention, which, however, should not be taken to be limitative to the invention, but are for explanation and understanding only.

In the drawings:

FIG. 1 is a block diagram showing the first embodiment of an information providing system according to the present invention;

FIG. 2 is an operational flowchart of the first embodiment of the information providing system according to the present invention;

FIG. 3 is an illustration of an example of a text retrieval information table in the first embodiment of the information providing system according to the present invention;

FIG. 4 is an illustration of an example of a history retrieval information table in the first embodiment of the information providing system according to the present invention;

FIG. 5 is an illustration of an example of updating of the history retrieval information table of FIG. 4;

FIG. 6 is an illustration of an example of updating of the text retrieval information table of FIG. 3;

FIG. 7 is an example of display on a user terminal in the first embodiment of the information providing system according to the present invention;

FIG. 8 is an operational flowchart of the second embodiment of the information providing system according to the present invention;

FIG. 9 is an illustration showing an example of updating of the text retrieval information table of FIG. 6;

FIG. 10 is an illustration showing an example of display on the user terminal of the second embodiment of the information providing system according to the present invention;

FIG. 11 is a block diagram showing a construction of the third embodiment of the information providing system according to the present invention;

FIG. 12 is an operational flowchart of the third embodiment of the information providing system according to the present invention;

FIG. 13 is an illustration showing an example of the text retrieval information table in the third embodiment of the information providing system according to the present invention;

FIG. 14 is an illustration showing an example of a position information table in the third embodiment of the information providing system according to the present invention;

FIG. 15 is an illustration showing an example of the history retrieval information table in the third embodiment of the information providing system according to the present invention;

FIG. 16 is an illustration showing an example of updating of the text retrieval information table of FIG. 13;

FIG. 17 is an illustration showing an example of updating of the position information table of FIG. 13;

FIG. 18 is an illustration showing an example of display on the user terminal in the third embodiment of the information providing system according to the present invention;

FIG. 19 is an illustration showing a construction of the fourth embodiment of the information providing system according to the present invention;

FIG. 20 is an operational flowchart of the fourth embodiment of the information providing system according to the present invention;

FIG. 21 is an illustration showing an example of a date and time information table in the fourth embodiment of the information providing system according to the present invention; and

FIG. 22 is an illustration showing an example of display on the user terminal in the fourth embodiment of the information providing system according to the present invention;

### DESCRIPTION OF THE PREFERRED EMBODIMENT

The present invention will be discussed hereinafter in detail in terms of the preferred embodiment of an information providing system, an information providing method, an information providing apparatus and a terminal to be used for implementing the information providing method, in accordance with the present invention with reference to the accompanying drawings. In the following description, numerous specific details are set forth in order to provide a thorough understanding of the present invention.

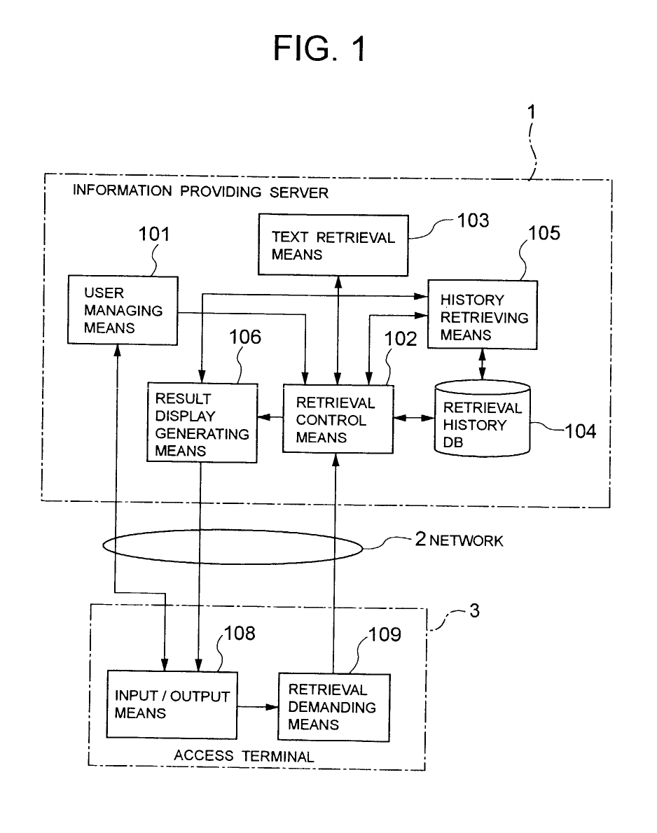

FIG. 1 is a block diagram showing a construction of the first embodiment of an information providing system according to the present invention. As shown in FIG. 1, the first embodiment of the information providing system includes an information providing server 1, an access terminal 3 as a user terminal, and a network 2 connecting between the information providing server 1 and the access terminal 3.

The information providing server 1 includes user managing means 101, retrieval control means 102, document retrieving means 103, a retrieval history DB (data base) 104, history retrieving means 105, result display generating means 106. On the other hand, the access terminal 3 includes input/output means 108 and retrieval demanding means 109.

The input/output means 108 forming the access terminal 3 performs authentication process for a user currently in access by communicating with the user managing means 101. The input/output means 108 of the access terminal 3 also communicate with the retrieval demanding means 109 to notify a retrieval demand from the user and to display a result of retrieval to the user. The retrieval demanding means 109 notifies the retrieval demand from the input/output means 108 to the retrieval control means 102.

The user managing means 101 forming the information providing server 1 performs authentication process for the user via the input/output means 108 to notify a user ID of the user currently using the system to the retrieval control means 102. The retrieval control means 102 generates a new retrieval demand ID per the retrieval demand from the retrieval demanding means 109 to receive a text retrieval result as response from the text retrieval means 103.

On the other hand, the retrieval control means 102 stores the retrieval demand from the retrieval demanding means 109, the text retrieval result from the document retrieving means 103, the user ID and date and time information from the user managing means 101 in the retrieval history DB 104 as the retrieval history data in association with the retrieval demand ID. Furthermore, the retrieval demand from the retrieval demanding means 109 is notified to the history retrieving means 105. On the other hand, the history retrieval result as the result of response is received by the history retrieving means 105. Similarly to the case of text retrieval, the user ID from the user managing means 101 and the date and time information are stored in the retrieval history DB 104 as retrieval history data in association with the retrieval demand ID. Finally, the retrieval demand ID is transferred to the result display generating means 106.

The result display generating means 106 feeds the retrieval demand ID received from the retrieval control means 102 to the history retrieving means 105 and receives the retrieval history data containing corresponding the text retrieval result and the history retrieval result to combine both retrieval result contained in the retrieval history data to generate a result output to transfer to the input/output means 108. In this case, in the retrieval history data, both retrieval results are not necessarily present so that the results may be not combined and one retrieval result may be displayed.

The text retrieval means 103 receives the retrieval demand from the retrieval control means 102 to execute retrieval according to designated condition to return the text retrieval result to the retrieval control means 102. The history retrieving means 105 receives the retrieval demand of the user from the retrieval control means 102, retrieves the retrieval history DB 104 with taking the received retrieval demand as condition, and notifies the retrieval history data to the retrieval control means 102 if any. The history retrieving means 105 receives the retrieval demand ID from the result display generating means 106 and returns the retrieval history data.

The retrieval history DB 104 stores the retrieving condition notified from the retrieval control means 102 and the text retrieval result or the history retrieval result in association with the user ID, date and time information and the retrieval demand ID, as the retrieval history data.

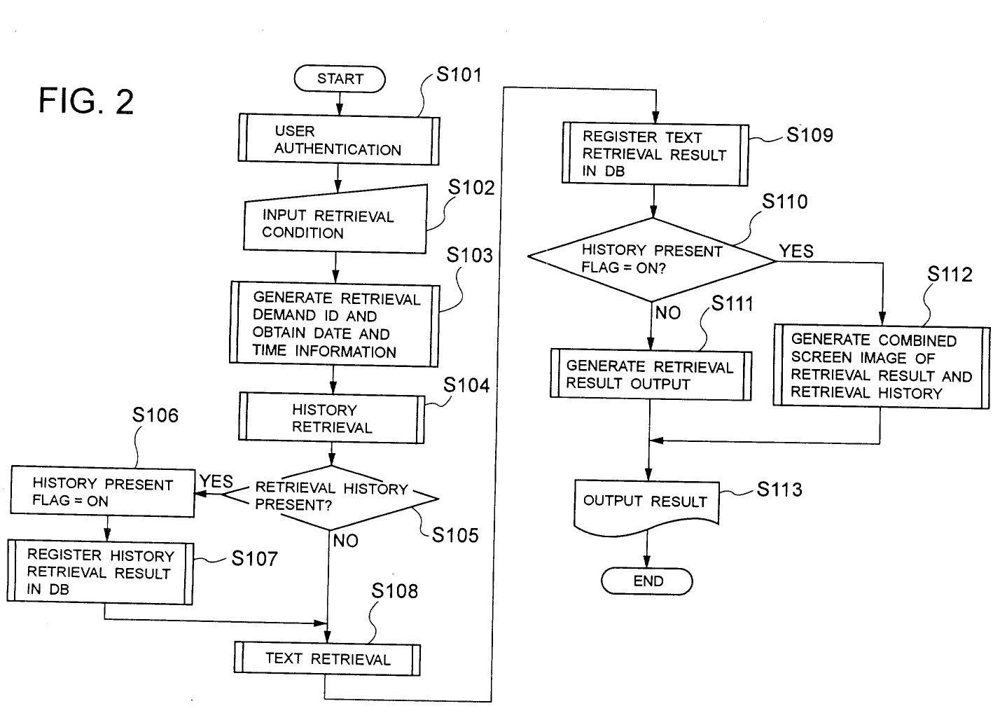

Next, operation of the first embodiment of the information providing system according to the present invention will be discussed. FIG. 2 is a flowchart showing one example of a flow of the overall process of the first embodiment of the present invention. At first, at step S101, authentication process for the user accessing the system is performed. The authentication process is performed by communication with the user managing means 101 via the input/output means 108 forming the access terminal 3. For example, authentication may be performed by utilizing the user ID and password. In the alternative, when the web browser is used as the input/output means 108, authentication process may be performed by utilizing COOKIE. After completion of authentication, the user ID is notified to the retrieval control means 102.

Next, at step S102, input of the retrieving condition from the user is received. The retrieving condition is designation of the retrieving condition to be issued for the document retrieving means 103. For example, the keyword or the like to be the retrieving condition is input. This process is performed by the input/output means 108. The information thus input us notified to the retrieval control means 102 on the server from the access terminal 107 via the retrieval demanding means 109.

Next, at step S103, generation of the retrieval ID uniquely corresponded to the current retrieval demand is performed. On the other hand, at the same time, the retrieval executing date and time can be obtained. These two information are used upon storing the retrieval result in the retrieval history DB 104 in the subsequent steps. Next, at step S104, retrieval is performed whether the retrieval demand condition of the same user in the past matching with the current retrieval demand condition is present in the history. When the matching retrieval demand condition is found, a list of the retrieval demand IDs on the retrieval history DB 104 is received as a result. On the other hand, a “history flag” indicating that some history retrieval results are obtained, is set “ON”. Furthermore, the result of the history retrieval result is registered in the retrieval history DB 104 as the retrieval history data together with the user ID and the retrieval demand ID, and the date and time information (steps S105, S106, S107).

Next, at step S108, the text retrieval process is executed according to the retrieval condition of the user. This is processed in the text retrieval means 103 and a list of document information (such as list of address in case of WWW pages) matching with the retrieval condition is notified from the retrieval control means 102, as the text retrieval result. As the text retrieval means 103, WWW search engine and so forth may be used.

Next, at step S109, the text retrieval result obtained at step S108 is received and registered in the retrieval history DB 104 as the retrieval history data. The registered retrieval history data is consisted of set of information of the user ID notified from the user managing means 101, the retrieval demand ID generated per retrieval demand in the retrieval control means 102, the retrieval condition of the user notified from the retrieval demand means 109, the document information list from the document retrieving means 103 as the result of text retrieval performed under the condition designated by the user and the retrieval executed date and time.

Through the process from step S103 to S109, process is performed mainly by the retrieval control means 102 as well as the user managing means 101, the document retrieving means 103, the history retrieving means 105 and the retrieval history DB 104. On the other hand, from the next step S110, the process is performed by the result display generation means 106 and the input/output means 108.

At step S110, the process is branched to step S111 or S112 depending upon whether the history retrieval results is obtained at step S104 or not. When the history retrieval result is not obtained, the result display screen containing only retrieval result obtained at step S108 is generated at step S111. Here, the retrieval result is obtained by retrieving the retrieval history DB 104 with taking the retrieval demand ID generated at step S103 as key. Other than the method set forth above, the retrieval results at step S108 per se are stored in a memory or a magnetic disk to use as they are.

Next, when the history retrieval result is obtained, at step S112, the result display output is generated by combining the text retrieval result and the history retrieval result currently retrieved. For example, when the information the same as the history retrieval result is contained in the currently obtained text retrieval result, the result display output with varying the display color for the relevant portion is generated. The result of history retrieval is similar to the case of step S111, the retrieval is performed on the retrieval history DB 104 with tasking the retrieval demand ID as the key. Then, among the currently obtained text retrieval result (the result of retrieval at step S108) and the past retrieval history (the result of retrieval at step S104), concerning the retrieval history information, retrieval on the retrieval history DB 104 is further performed with the resultant retrieval demand ID to obtain the text retrieval result actually executed in the past.

In the flowchart of FIG. 2, at first, after performing history retrieval at step S104, the text retrieval is performed at step S108. However, it is possible to perform the text retrieval at earlier timing than history retrieval. As alternative method, similarly to the case discussed in connection with step S110, it is possible to store the retrieval results at steps S108 and S104 in the memory or the magnetic disk to use as they are. The processes at steps S110, S111 and S112 are performed in the result display generating means 106. The generated result display output is fed to the input/output means 108 to be output to be displayed to the user, finally at step S113.

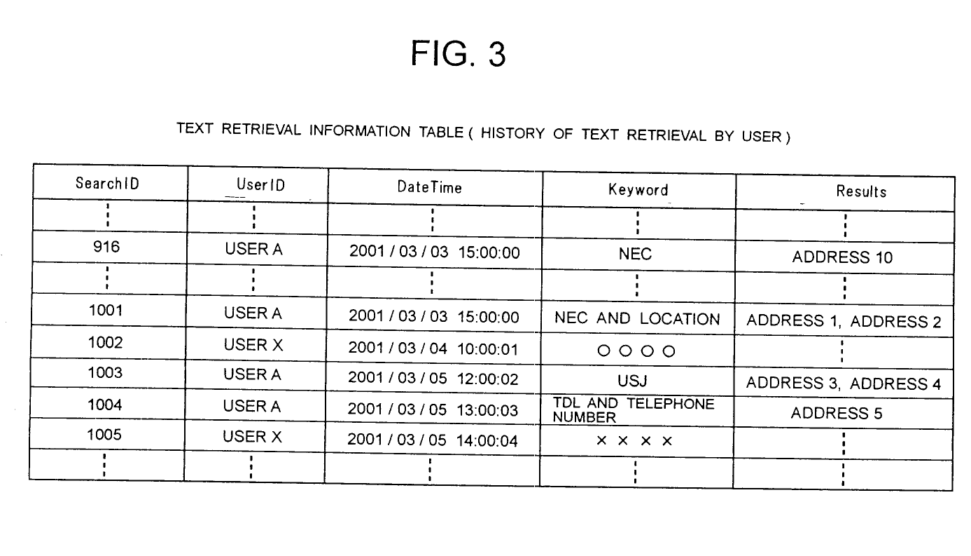

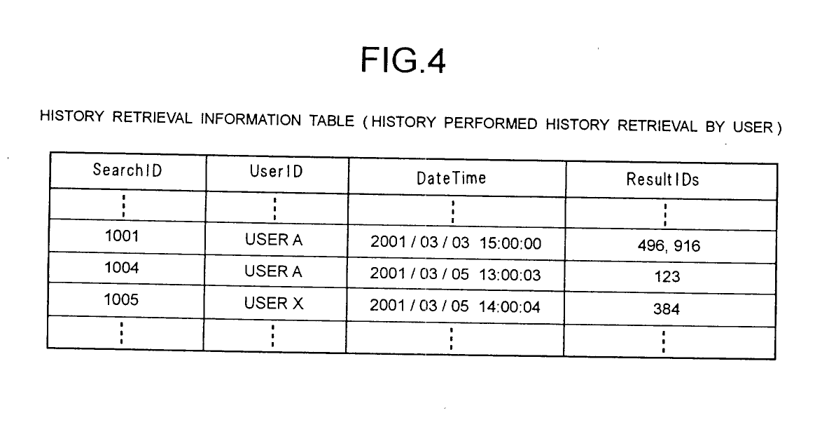

Next, flow of process of the first embodiment of the present invention will be discussed as particular embodiment. For example, consideration is given for the case where a certain user utilizes the first embodiment of the present invention for retrieval or searching of WWW. At first, authentication process is performed at step S101. The user ID of the user is assumed as “UserA”. On the other hand, it is assumed that the past retrieval history data of the user has already been stored in the retrieval history DB 104. FIGS. 3 and 4 show particular examples of database tables in the retrieval history DB 104 including the retrieval history data of a plurality of users. FIG. 3 is a text retrieval information table storing the history of the text retrieval performed by the user, and FIG. 4 is a history retrieval information table storing the history of the history retrieval by the user.

In FIGS. 3 and 4, “SearchID” is the retrieval demand ID, “UserID” is the user ID, “DateTime” is date and time information. On the other hand, in FIG. 3, “Keyword” is the retrieval condition input by the user, “Results” is the list of the address of WWW page indicative of the result of text retrieval. On the other hand, in FIG. 4, “ResultIDs” is a list of the past retrieval demand ID hit in the history retrieval.

Next, it is assumed that the user input “NEC and Telephone number” as retrieval condition (step S102). For this retrieval demand, the system assigns date and time “13/03/2001 18:22:12” and retrieval demand ID “1234”. These information are stored in the memory and the magnetic disk so that the stored information can be used in the subsequent steps.

Next, utilizing the retrieval condition input by the user, the history retrieval means 105 performs retrieval on the retrieval history DB. In greater detail, retrieval on the text retrieval information table shown in FIG. 3 is performed to find data on the table matching with the retrieval condition of the user and the user ID. At this time, it is not required to complete matching of the keywords input by the user but can take those partially matching with the keyword as the retrieval result. In case of the example shown in FIG. 3, it is assumed that those having “SearchID” of 916, 1001, 1004 partly containing “NEC” or “telephone number” as the keywords are returned as results of history retrieval (step S104).

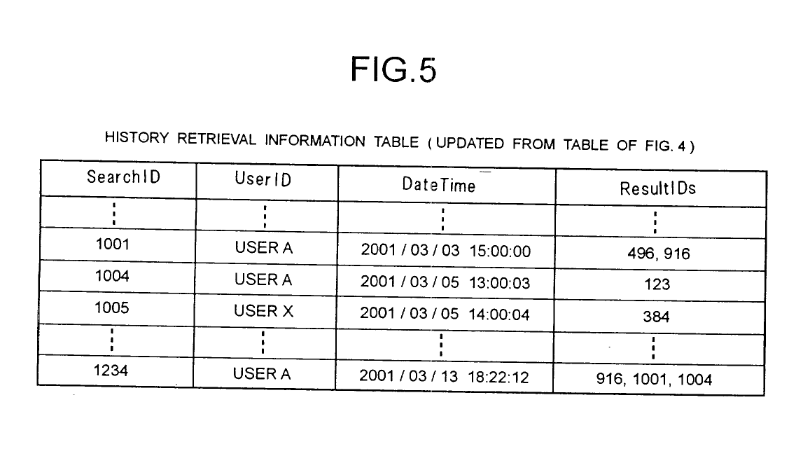

Since more than one data is found as a result of history retrieval, “history present flag” is set to “ON”, and the history retrieval result is registered in the history retrieval information table of the history retrieval DB 104. The information herewith registered is the retrieval demand ID “1234”,date and time “13/03/2001 18:22:21”, the user ID “UserA” and the past retrieval demand ID “916, 1001, 1004” contained in the history retrieval result. FIG. 5 shows one example of the history retrieval information table after registering data.

Next, at step S108, retrieval of WWW page is performed according to the retrieval condition of the user. For example, utilizing the search engine of WWW page or the like as existing technology, the user may obtain the address list of the page relating to the input keywords. Here, as result of retrieval, “Address11” and “Address12”, are obtained.

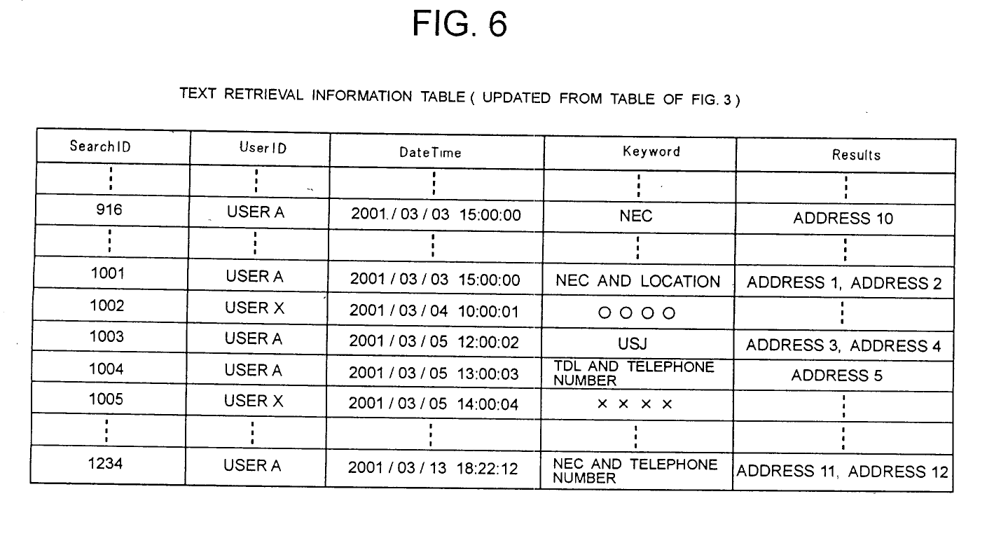

At step S109, the text retrieval result obtained in the preceding step is registered in the text retrieval table of the retrieval history DB 104. The information registered herein are the retrieval demand ID “1234”, date and time “13/03/2001 18:22:21”, the user ID “UserA”, the retrieval condition “NEC and Telephone number” and addresses of WWW pages “Address11, Address12”. FIG. 6 shows one example of the text retrieval information table after registration of the data.

At step S110, the process is branched depending upon presence and absence of the history retrieval result obtained at step S104. In the shown embodiment, this judgment is made by making reference to the “history present flag” set at step S106”. However, it is also possible to make judgment whether the history information is contained in the obtained retrieval result by performing retrieval on the retrieval history DB 104 by notifying the current retrieval demand ID held on the magnetic disk or the memory to the history retrieval means 105.

In case of the particular embodiment, since the history retrieval result is present, the process is advanced to step S112. At step S112, the current retrieval demand ID is read out from the magnetic disk or the memory to be notified to the history retrieving means 105. Then, retrieval on the retrieval history DB 104 is performed to obtain the current text retrieval result. In case of the shown example, for the retrieval demand ID 1234, the text retrieval result “Address11, Address12”, the retrieval keywords “NEC and Telephone number”, and the past retrieval demand ID string “916, 1001, 1004” are obtained.

Furthermore, by performing retrieval on the document information retrieval table with taking the ID string of the history as key, again, past retrieval content and the text retrieval result are obtained. In the shown case, for the retrieval ID “916”, the retrieval date and time “3rd March, 2001”, the retrieval word “NEC”, text retrieval result “Address10” and so forth can be obtained. For remaining retrieval demand ID1001, 1004, similar information can be obtained.

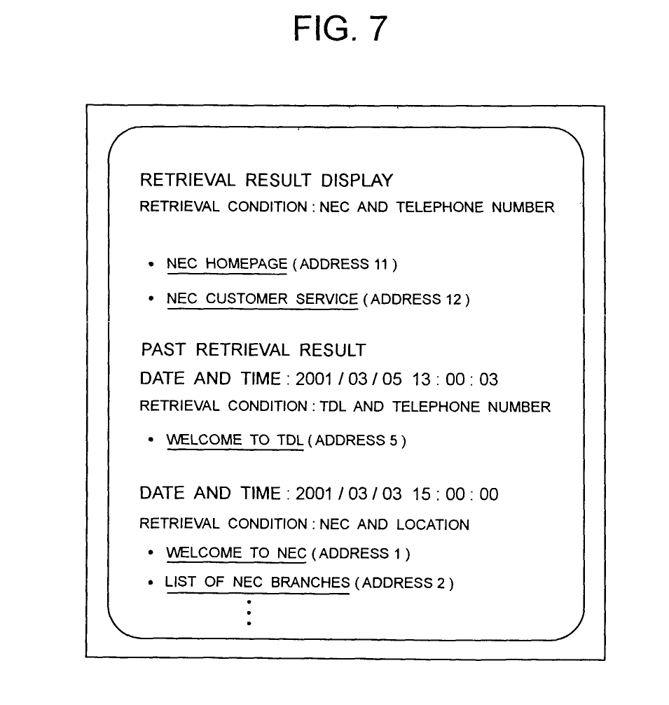

At step S112, so that these information can be presented on the screen simultaneously, the information is constructed as shown in FIG. 7, for example. Next, at step S113, display is performed for the user. FIG. 7 shows one example of display of the screen image constructed at step S113 on the WWW browser. On the upper portion of the screen, titles and addresses of the pages as the current text retrieval result are displayed in a form of a list. On the lower portion, the current text retrieval result and relevant past text retrieval result are displayed.

The process at step S111 corresponds to the case where the history retrieval result at step S112 is not present, to obtain the information relating to the new retrieval result by procedure as set forth in connection with step S112, and is displayed to the user at step S113 after formation of the screen image similarly.

By the process set forth above, the user can be efficiently obtained the information by past own information retrieval and so forth. On the other hand, in the process set forth above, the user inputs only own retrieval demand to apply no additional load. On the other hand, in order to retrieve the retrieval result obtained by the past retrieval demand from the history in a form close to the current retrieval demand of the user, it is possible to notify the information which cannot be retrieved by the current retrieval demand but not far different from the current retrieval demand, to the user. Namely, it becomes possible to provide relevant information as much as possible from a little information input under mobile environment. On the other hand, by displaying the retrieval condition in addition to the retrieval result, the user may know the displayed retrieval result and for what application the user demanded retrieval in the past. Then, the user may expect the retrieval result even without seeing the detailed content of the displayed retrieval result.

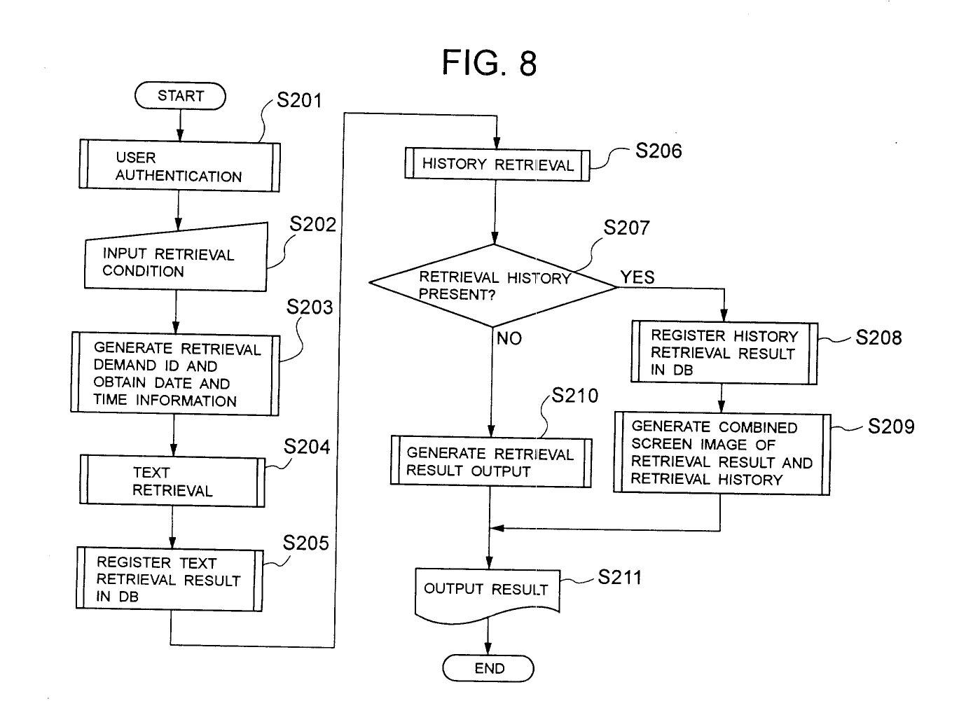

Next, discussion will be given for the second embodiment of the present invention. The construction of the shown embodiment is the same as the first embodiment shown in FIG. 1. However, as shown in FIG. 8, operation steps are differentiated. Namely, while the history retrieval is at first performed (step S104) in the first embodiment, the new text retrieval (step S204) is at first executed in the second embodiment to perform history retrieval (step S206) on the basis of the retrieval result.

Hereinafter, the operation of the second embodiment will be discussed with reference to FIG. 8. Steps S201, S202, S203 respectively correspond to steps S101, S102 and S103 of FIG. 2 to implement the same operation. The next step S204 corresponds to step S108 of FIG. 2 to execute the text retrieval process according to the retrieval condition input at step S202. The result of text retrieval is registered in the retrieval history DB 104 as the retrieval history data at next step S205. The registered data contains a list of the user ID, the retrieval demand ID, the retrieval implemented date and time, the retrieval condition and the text retrieval result.

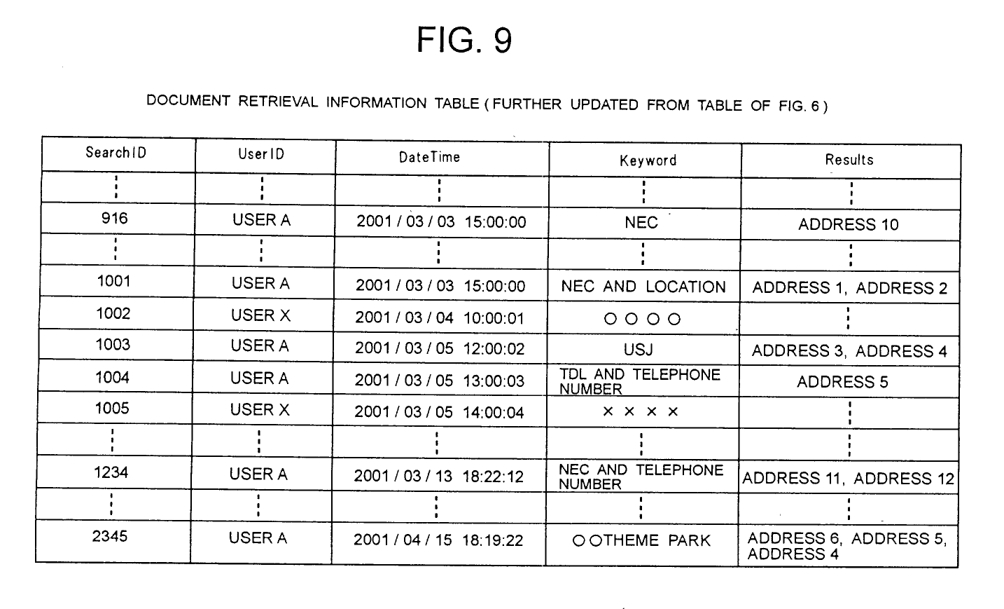

For example, it is assumed that, for the retrieval demand ID “2345” of the user “UserA”, the retrieval condition “oo theme park”, the retrieval results “Address6, Address5, Address4” are obtained. Data shown in FIG. 9 is newly registered in the text retrieval information table.

Next, at step S206, the history retrieval means 105 performs retrieval on the text retrieval information table in the retrieval history DB 104. However, different from the first embodiment, retrieval is performed with taking the retrieval result information at the foregoing step S204 as key. Namely, in the shown embodiment, retrieval containing “Address6”, “Address5” or “Address4” as the current retrieval result in the Result field as an item indicating the retrieval result in the table, is performed. As a result, the retrieval demand ID “1004” and “1003”, containing the retrieval result of “Address5” and “Address4” can be obtained.

Next, the operation of the next step S207 is the same operation as the step S105 of the first embodiment. By the step S207, the process is branched to step S208 and S210 depending upon presence or absence of the result of history retrieval. When the history retrieval result is present, the process is advanced to step S208 to register the result of the retrieval history DB 104 similar to the operation of the step S107 of the first embodiment. Furthermore, at next step S209, the result of new retrieval and the result of history retrieval are combined to display to the user at step S211. The operations of these two steps S208 and S209 are also the same as those in the first embodiment.

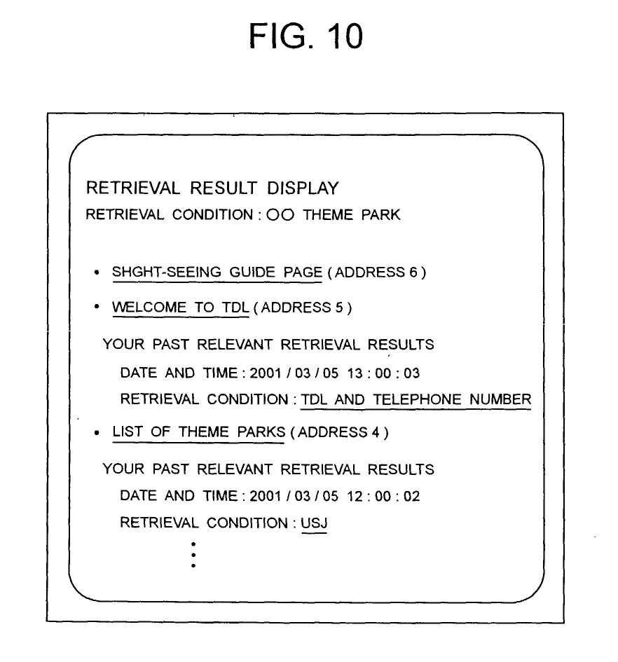

FIG. 10 shows display of one example of screen image combined at step S209 by the WWW browser. On the screen image, the list of the titles and addresses of the retrieval result pages is displayed. For the retrieval results matching with the past retrieval, the past retrieval contents are displayed in addition. The item of the retrieval condition of the past retrieval content is formulated as hyper link to display the screen image showing the retrieval result performed in the past, by clicking the hyper link. On the other hand, when the result of history retrieval is not present, the process is advanced to step S210 to form the screen image only by the text retrieval result similarly to the case of step S111 of the operation in the first embodiment to display to the user at step S209.

As set forth above, the user may efficiently obtain the result of currently performed retrieval and the related own retrieval content in the past. In the process, the user is not required any effort to find out information among a list of past bookmark. On the other hand, the result of current retrieval demand made by the user may know how the result of the text retrieval was obtained in the past. Therefore, the user may know the use of the retrieval result which is not considered at the present.

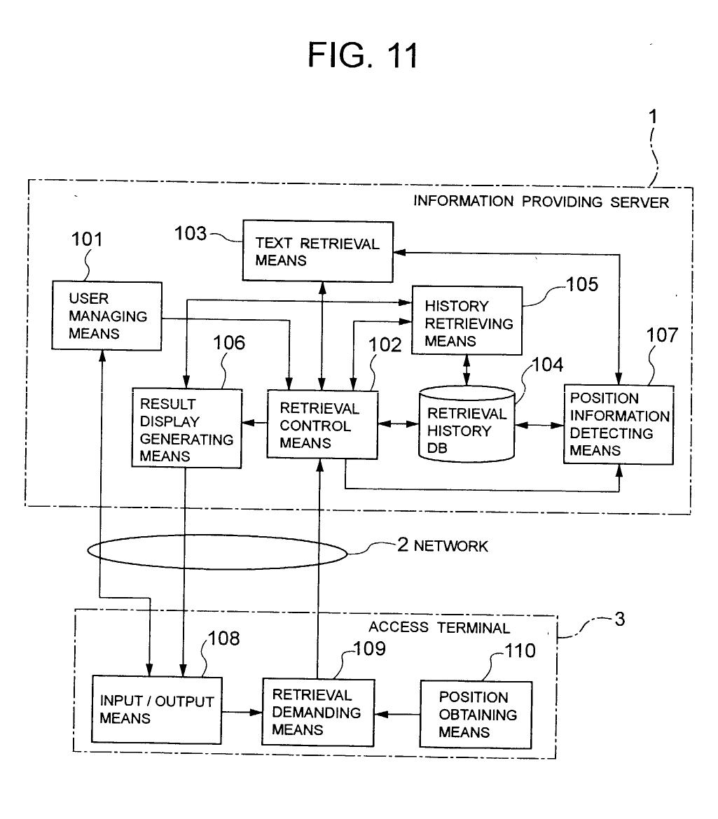

Next, discussion will be given for the third embodiment of the present invention. FIG. 11 is a block diagram showing a construction of the third embodiment of the present invention. Throughout the disclosure, like elements to those in FIG. 1 will be identified by like reference numerals and detailed description for such common elements will be eliminated for avoiding redundant disclosure to keep the disclosure simple enough to facilitate clear understanding of the present invention. As shown in FIG. 11, in the third embodiment of the present invention, position information extracting means 107 is added to the information providing server 1, and position obtaining means 110 is added to the access terminal 3. These two elements are different from the construction of the first embodiment shown in FIG. 1.

The input/output means 108 forming the access terminal 107 performs authentication process for the user currently in access by communication with the user managing means 101. On the other hand, by communication with the retrieval demanding means 109, demand for retrieval from the user and displaying of the retrieval result to the user are performed. The position obtaining means 110 obtains the information of the current position of the access terminal 3 to notify the information to the retrieval demanding means 109. The retrieval demanding means 109 notifies the retrieval demand of the user from the input/output means 108 and the current position from the position obtaining means 110 to the retrieval control means 102. The user managing means 101 communicates with the input/output means 108 to perform authentication process of the user and notifies the user ID of the user currently using the system to the retrieval control means 102.

The retrieval control means 102 generates new retrieval demand ID per retrieval demand from the retrieval demanding means 109 to notify the retrieval demand from the retrieval demanding means 109 to the document retrieving means 103, and receives the retrieval result as response from the text retrieval means 103. On the other hand, retrieval demand from the retrieval demanding means 109 and the current position information, namely the information of the position where the retrieval demand is issued, and the text retrieval result from the text retrieval means 103 are stored in the retrieval history DB 104 as the retrieval history data with association with the user ID from the user managing means 101, the time information and the retrieval demand ID. At the same time, the retrieval demand ID corresponding to the registered retrieval history data is notified to the position information extracting means 301. Furthermore, the current position information from the retrieval demanding means 109 notifies to the history retrieval means 105, and receives the history retrieval result as the response from the history retrieving means 105. Similarly to the case of the text retrieval, history retrieval result is stored in the retrieval history DB 104 as the retrieval history data in association with the user ID from the user managing means 101 and the time information, and the retrieval demand ID. Finally, the retrieval demand ID is transferred to the result display generation means 106.

The result display generation means 106 feeds the retrieval demand ID received from the retrieval control means 102 to the history retrieving means 105 and receives the retrieval history data including the relevant text retrieval result or the history retrieval result to generate a result output by combining both retrieval result contained in the retrieval history data to transfer to the input/output means 108. In this case, both retrieval results are not necessarily present, and one of the retrieval results can be displayed without being combined with the other.

The text retrieval means 103 receives the retrieval demand from the retrieval control means 102 to execute retrieval according to the designated condition to return the result of retrieval to the retrieval control means 102. On the other hand, the text retrieval means 103 also receives the retrieval demand of the document from the position information extracting means 107 to return the content of the document.

The history retrieval means 105 receives the current position information from the retrieval control means 102, performs retrieval on the retrieval history DB 104 with taking the current position information as retrieval condition, and notifies to the retrieval control means 102 if the history data is present. The history retrieval means 105 receives the retrieval demand ID from the result display generation 106 to return the retrieval history data.

The position information extracting means 107 receives the retrieval demand ID from the retrieval control means 102, performs retrieval on the retrieval history DB with the retrieval demand ID, and extracts the position informtaion contained in the text retrieval result by the document retrieving means 103 to add the position information to the corresponding retrieval history data.

The retrieval history DB 104 stores the retrieval condition notified from the retrieval control means 102, the position information relating to the site where the user issues the retrieval demand, and the text retrieval result or the history retrieval result, in association with the user ID and the date and time information, the retrieval demand ID and the position information extracted from the retrieval result in the position information extracting means 107, as the retrieval history data.

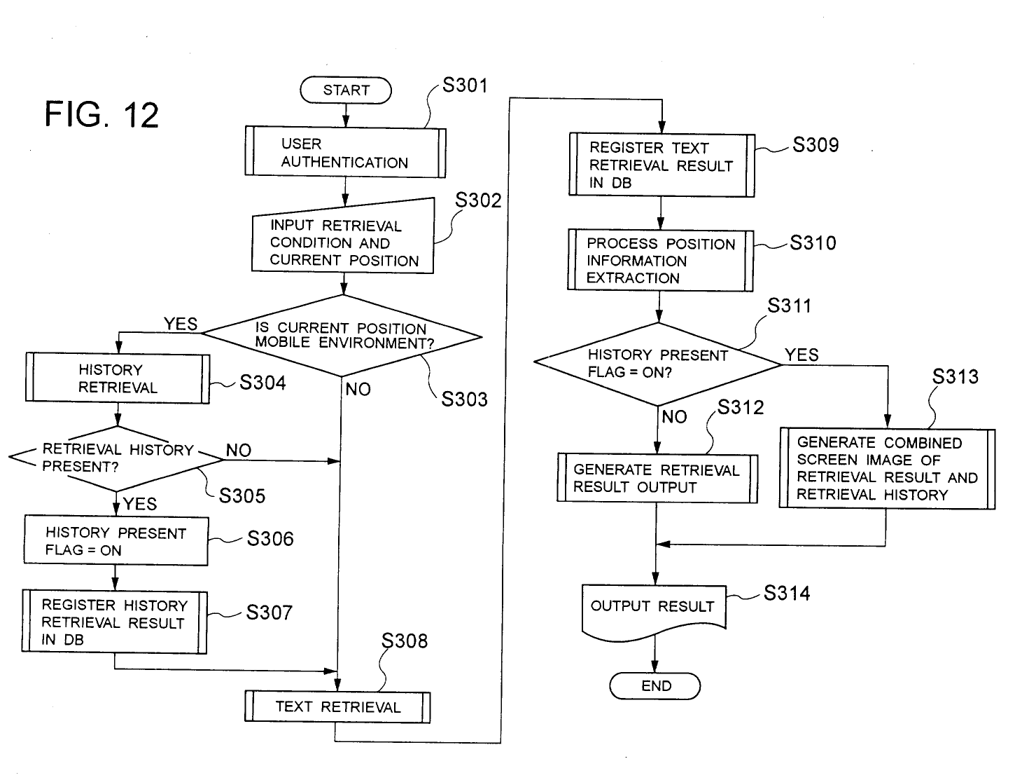

Next, discussion will be one example of the flowcharts given for the operation of the third embodiment of the present invention showing the overall process of the shown embodiment of the invention shown in FIG. 12. At first, at step S301, authentication process for the user accessing the system is performed. This is performed by communication with the user managing means 101 via the input/output means 108 forming the access terminal 107. For example, authentication process may be performed on the basis of the user ID and password. In the alternative, when the web browser is used as the input/output means 108, authentication process may be performed utilizing COOKIE or the like. After authentication, the user ID is notified to the retrieval control means 102. This process is the same as the operation at step S101 of the first embodiment.

Next, at step S302, input of the retrieval condition from the user and the current position where the user uses the system is received. The retrieval condition is a designation of the retrieval condition to be issued by the user to the text retrieving means 103. For example, the keyword or the like, with which the user desires to perform retrieval, may be the retrieval condition. On the other hand, the current position is obtained by the position obtaining means 110. The position information obtained by the position obtaining means 110 is received as the current position information of the user. When the access terminal is stationary at the office or home, the position obtaining means 110 may notify a particular symbol representative of the place to the retrieval demanding means 109. On the other hand, when the access terminal 107 is the mobile terminal, latitude and longitude information of the position of the user is obtained using GPS (Global Positioning System), and place name is obtained corresponding to the latitude and the longitude utilizing the map data base as used in the navigation system. Then, the place name is notified to the retrieval demanding means 109.

At step S303, judgment is made whether the user is accessing the system from the site other than the home or the office, namely from the mobile terminal. This is done by receiving the current position information of the user from the retrieval demanding means 109 in the retrieval control means 102 and by comparing thus received current position information with the site information of the home and/or the office preliminarily registered by the user, for judgment. When the user is in access under mobile environment, the process is advanced to step S304, and otherwise to step S308.

When the user is in access under mobile environment, retrieval on the retrieval history DB 104 is performed whether the information relating to the current position of the user is present or not. As a retrieval method, it is considered to take the position information extracted from the information of the text retrieval result in the past contained in the retrieval history data stored in the retrieval history DB 104, as object. In the alternative, it is also considered to take the retrieval condition input by the user in the past contained in the retrieval history data, as object. The process here is performed by requesting retrieval to the history retrieval means 105 with taking the current position information of the user and the user ID as keyword and executing history retrieval on the retrieval history DB 104 by the history retrieval means 105. When the retrieval history data matching with the condition is found, the list of the retrieval demand ID contained in the found retrieval history data is received as the history retrieval result. On the other hand, a “history flag” indicative that some history retrieval result is obtained, is set ON.

Furthermore, the result of history retrieval is registered in the retrieval history DB 104 as the history retrieval data together with the user ID, the retrieval demand ID and the retrieval execution date and time information (steps S305, S306 and S307). Next, either in mobile environment or other environment, retrieval process for the retrieval demand of the user is performed at step S308. This is processed in the text retrieval means 103 and document information (e.g. list of address incase of WWW page) matching with the retrieval condition of the user, such as keyword, notified from the retrieval control means 102 is returned as the text retrieval result. As the text retrieval means 103, the existing database system having retrieval function by a keyword, or search engine of WWW when the information on the Internet is taken as object, may be used.

Next, at step 309, the retrieval result at step S308 is received to store in the retrieval history DB 104 as the retrieval history data. The registered retrieval history data contains a set of the user ID notified from the user managing means 101, the retrieval demand ID generated per the retrieval demand in the retrieval control means 102, the current position information notified from the retrieval demand means 109, namely the place information relating to the site at which the retrieval demand is issued, the retrieval condition of the user, the document information list as the text retrieval result by the keyword designated by the user from the document retrieving means 103, and the retrieval executing date and time.

At step 310, the information relating to the position is extracted from the document of the retrieval result currently to add in the retrieval history DB 104 as attribute information of the retrieval history data. For this purpose, the position information extracting means 107 receives the retrieval demand ID from the retrieval control means and further receives the list of the document information of the result of text retrieval contained in the corresponding retrieval history data, to notify the information to the document retrieving means 103 to receive the content of the document (or Web page).

Next, the position information extracting process for the content of the received document is performed to store the result in the retrieval history DB 104 in association with the retrieval history data as the extraction object. The process in the position information extracting means 107 is the process for extracting particular place name, position, building name or the like from the text information. In practice, the process can be realized by a method for matching a character string matching with the text of the retrieval result using the existing map database as dictionary, or a method derived in “Place name extraction method for encyclopedia text retrieval for sorting the retrieval result by zone” Information Processing Society of Japan, Natural Language Processing Study Group 99-7.

Next, at step S311, the process is branched to steps S312 and S313 depending upon whether the history retrieval results is obtained at step S304 or not. When the history retrieval result is not present, a display output of the text retrieval result obtained at step S308 is generated at step S312.

On the other hand, when the history retrieval result is present, the result display output is generated by combining the current retrieval result and the history retrieval result at step S313. For example, when the same information as that of the history retrieval result is contained in the current retrieval result, the result display output is generated with modifying the display color in the relevant portion. The processes at steps S311, 312 and 313 are performed in the result display generating means 106. The generated result display output is fed to the input/output means 108 for output display to the user at step S314.

Next, discussion will be given for the flow of the process of the third embodiment of the present invention in terms of the particular example. At first, authentication process is performed at step S301. It is assumed that the user ID is “UserA”. At first, when the user performs retrieval at the Office or Home, the retrieval result is displayed to the user through the processes at steps S302, S303, S308, S312 and S314. At the same time, data resulting from the retrieval is stored in the retrieval history DB 104 as the retrieval history information.

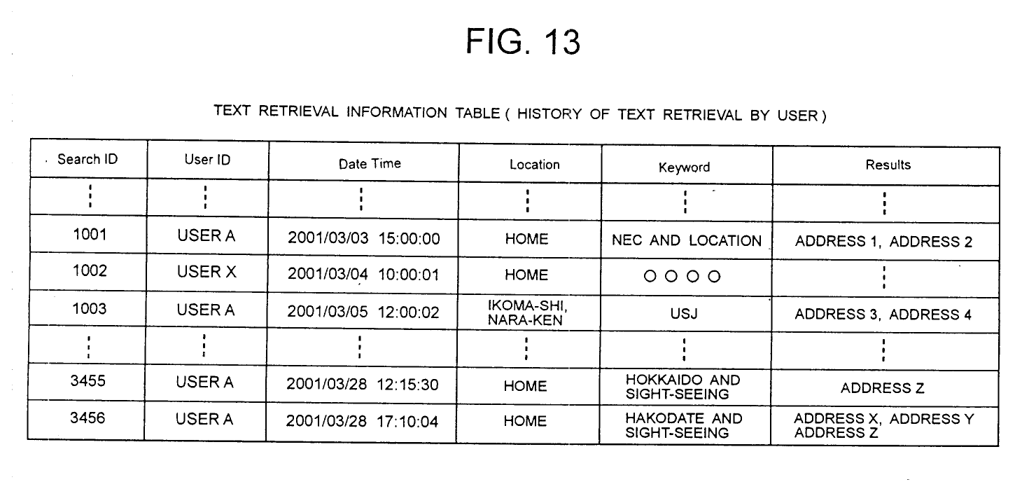

For example, it is assumed that the user performs retrieval for information relating to Hakodate (place name) for the purpose of sightseeing trip. At step S302, when the user inputs “Hakodate and Sightseeing” as retrieval condition, the system generates the retrieval demand ID “3456” in response thereto. At step S308, the text retrieval (in the case of this example, the Internet search) is executed. Here, it is further assumed that pages of addresses “AddressX”, “AddressY”, “AddressZ” are obtained as the result of text retrieval. At step S309, the text retrieval result is registered in the retrieval history DB 104 together with the user ID, the retrieval execution date and time, site information relating to the site where the user issued the retrieval demand and the retrieval demand ID. FIG. 13 shows one particular example of the table (text retrieval table) in the retrieval history DB 104 after registration of data.

Next, step S310, analysis of the page of the currently registered retrieval result is performed to extract information relating to the place. The position information extracting means 107 receives the retrieval demand ID “3456” from the retrieval control means 102 to obtain “AddressX”, “AddressY”, “AddressZ” as the page address of the retrieval result.

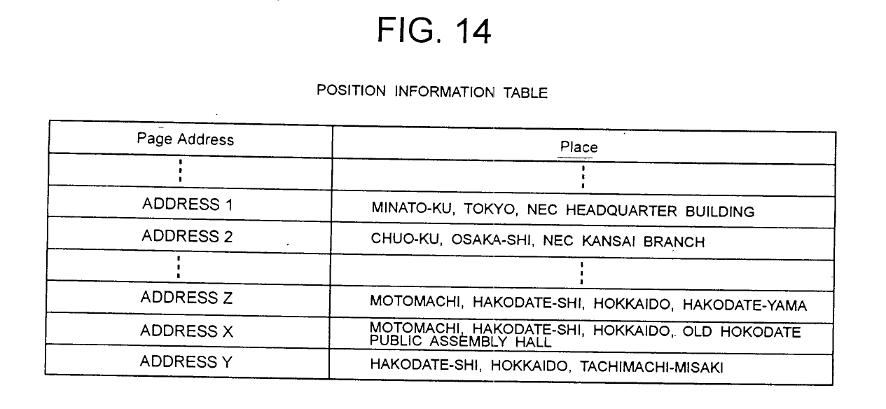

Then, the content of the page is obtained by notifying these information to the text retrieval means 103. It is assumed that the place name and building name, such as “Motomachi, Hakodate-shi”, “Hakodate Public Assembly Hall” for the page of the “Addressx”, are extracted through analysis of the obtained page. The information relating to the extracted positions are registered in the retrieval history DB 104 in association with the current retrieval result. FIG. 14 shows one particular example of the table (position information table) in the retrieval history DB 104 registered at this time, in which a set of the address of the page and the position information corresponding thereto are registered.

Next, at step S311, since the “history present flag” is not set ON, the process is advanced to step S312 to generate the retrieval result screen image at step S308 to be displayed to the user at step S314.

Next, discussion will be given for the case where the user uses this system later under mobile environment. In this case, in comparison the case where the system is accessed from the office or home in former case, processes at steps S304 to S307 are added. On the other hand, when the history retrieval result is obtained, the screen image generation process combining the history and the new text retrieval result is performed at step S313. For example, it is assumed that the user “UserA” accesses to the system at “Motomachi, Hakodate-shi”. At step S304, the position information table of the retrieval history DB 104 is retrieved for finding information containing “Motomachi, Hakodate-shi” in a field of “Place” indicative of the position information. Then, on the basis of the address information and the user ID obtained through the search, retrieval is performed on the text retrieval table to obtain retrieval information obtained in the past retrieval performed by the UserA.

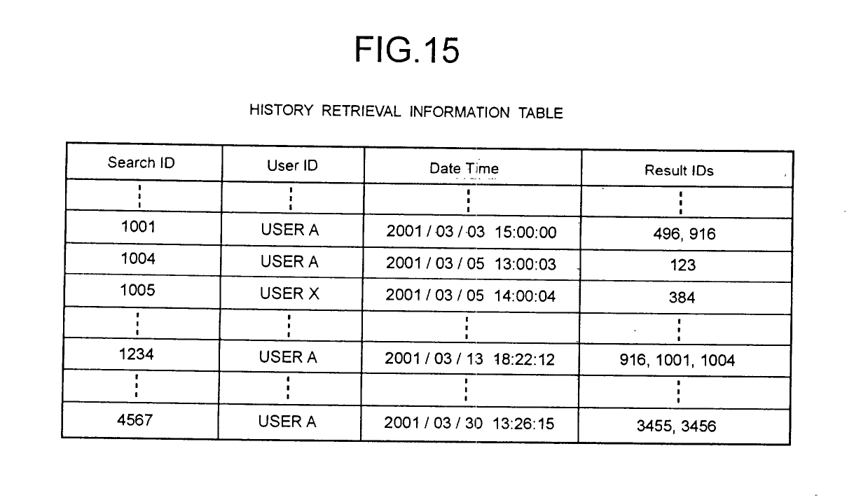

On the other hand, retrieval of respective fields of “Location” and “Keyword” of the text retrieval table is performed to obtain retrieval information containing “Motomachi, Hakodate-shi” in these fields. In case of this example, the retrieval results of the retrieval demand IDs “3455” and “3456” become the result. The history retrieval result is registered in the retrieval history DB 104 at step S307. FIG. 15 is one particular example (the retrieval demand ID for the current retrieval demand is assumed as “4567”) of the table (history retrieval information table in the retrieval history DB 104 after registration of the data.

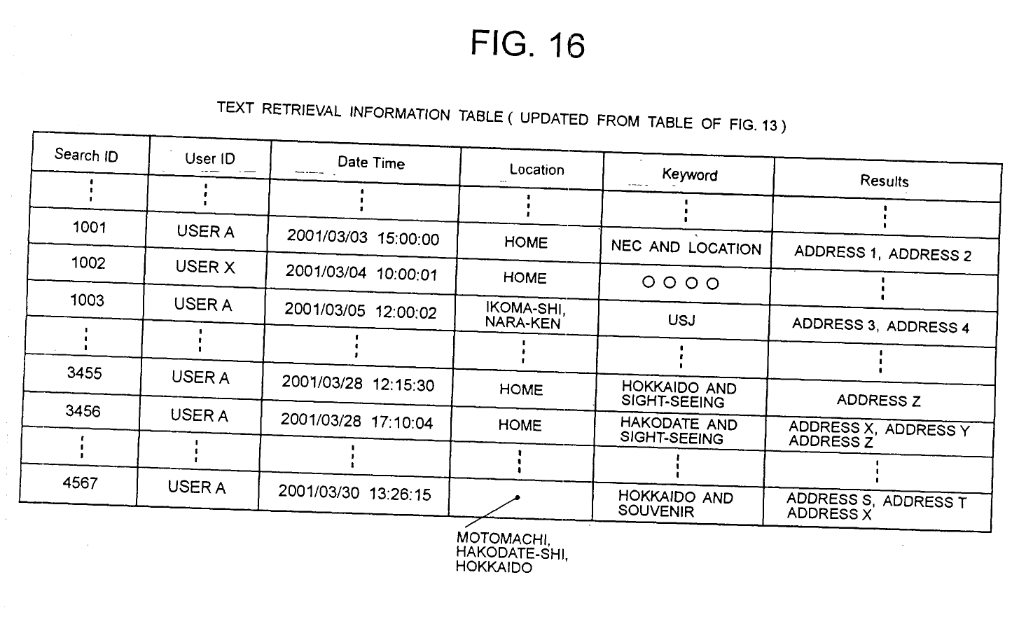

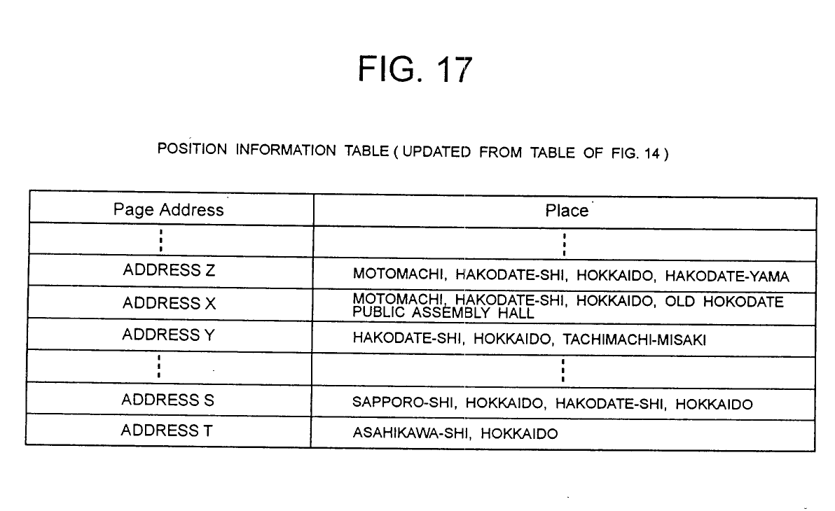

Processes at subsequent steps S308 to S310 are the dame as those in the case where the user accesses the system from the office or home. It is assumed that the retrieval condition input at step S302 by the user is “Hokkaido and souvenir”, data shown in FIGS. 16 and 17 is registered in the retrieval history DB 104 through the processes at steps S309 and S310.

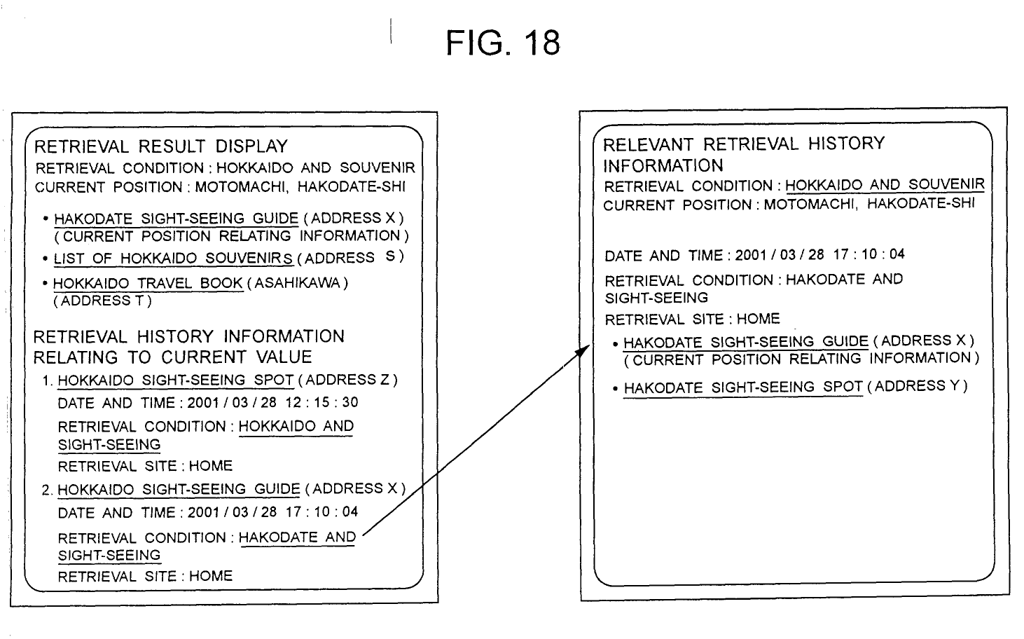

Next, at step S313, information of the new text retrieval result and the history retrieval result are combined to be output at step S314. Here, it is considered that the page containing position information close to the current position of the user is displayer preferentially and the page frequently appearing in the retrieval history matching with the condition, is displayed preferentially. The FIG. 18 shows the particular example of the display according to the third embodiment. On the display screen, together with the current retrieval result, information of the page relating to the current position among the past retrieval result is displayed. On the other hand, among the current retrieval result, those containing information relating to the current position may be displayed with indication “current position related information”. The item of the retrieval condition of the retrieval history information be establish hyper link so that the detailed information display screen of the retrieval history is shown on right side of FIG. 18, for example.

As set forth above, the user can efficiently obtain information relating to the current position with the past retrieved and accessed information.

It should be noted that the text retrieval process at step S308 is always performed in the shown embodiment. However, in the mobile environment, when express retrieval condition is not input from the user at step S302, it is possible to perform only history retrieval and not to perform new retrieval process. On the other hand, in the flowchart of FIG. 12, after performing history retrieval at step S304, document retrieval is performed at step S308. However, the text retrieval can be performed at earlier timing than the history retrieval.

On the other hand, the text retrieval result is registered in the retrieval history DB 104, and information whether the user actually accesses the page or not is also recorded to preferentially display the information accessed by the user in the past upon outputting the retrieval history result at step S313 upon used in the mobile environment.

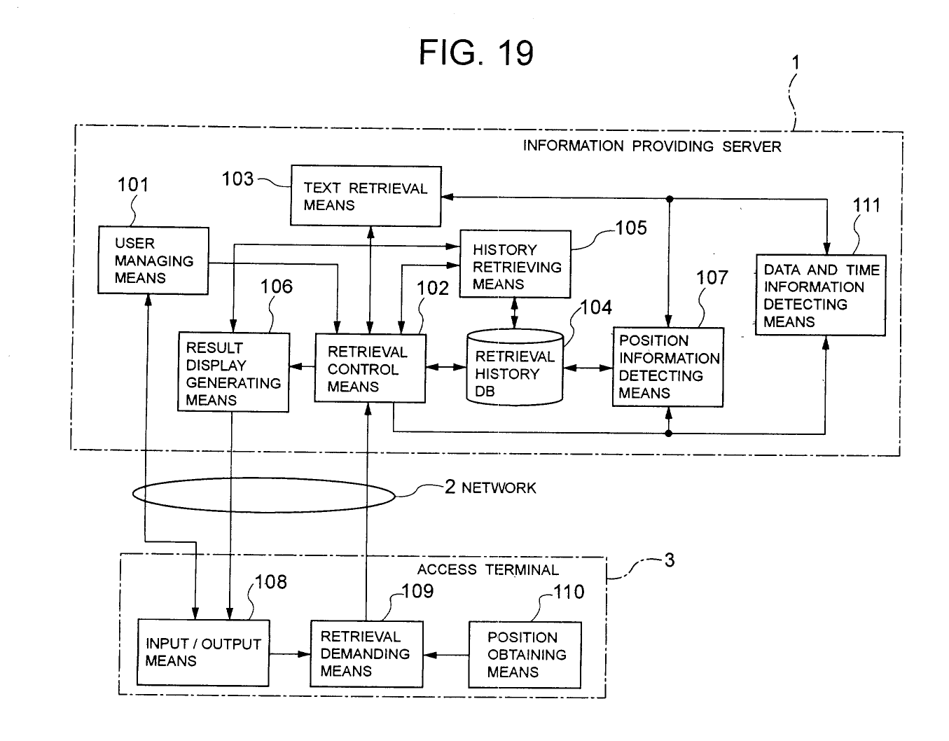

Next, discussion will be given for the fourth embodiment of the present invention. FIG. 19 is a block diagram showing the fourth embodiment of the present invention. Throughout the disclosure, like elements to those in FIGS. 1 and 11 will be identified by like reference numerals and detailed description for such common elements will be eliminated for avoiding redundant disclosure to keep the disclosure simple enough to facilitate clear understanding of the present invention. In FIG. 19, data and time information extracting means 111 is added to the construction of FIG. 11, and other construction is the same as those of FIG. 11. The date and time information extracting means 111 operates similar to the position information extracting means 107 to receive the retrieval demand ID from the retrieval control means 102 to perform retrieval on the retrieval history DB 104 with the retrieval demand ID to extract date and time information contained in the information of the past text retrieval result contained in the retrieval history data to add the date and time information in the corresponding retrieval history data.

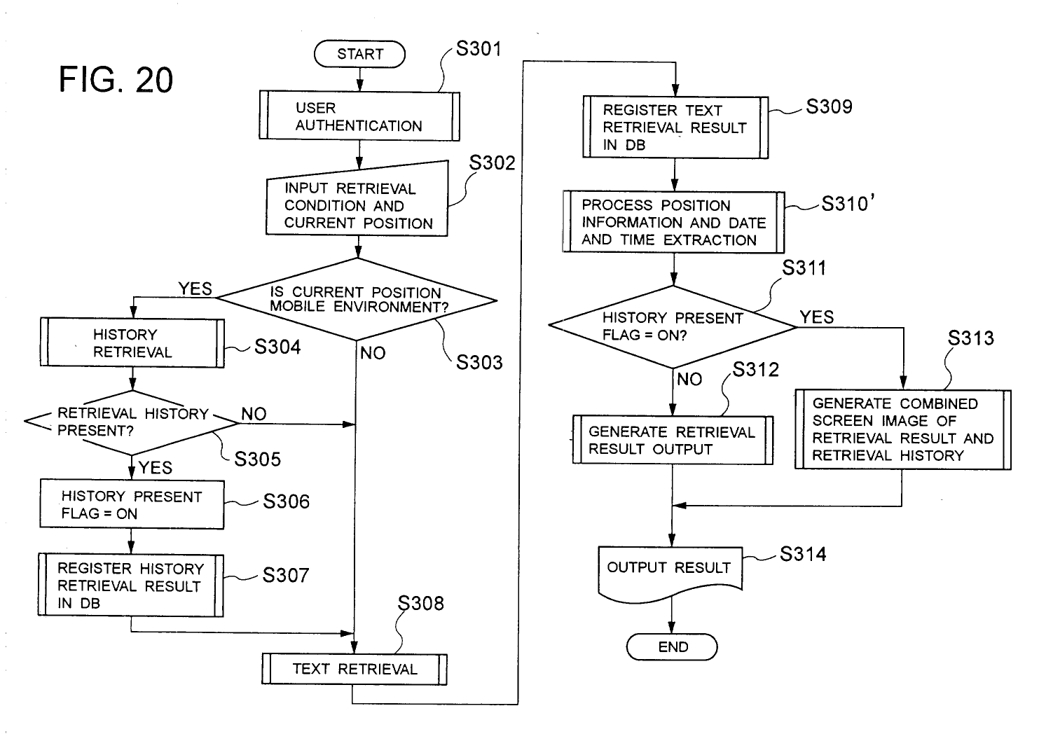

FIG. 20 is a flowchart showing operation of the shown embodiment. Throughout the disclosure, like steps to those in FIG. 12 will be identified by like steps and detailed description for such common elements will be eliminated for avoiding redundant disclosure to keep the disclosure simple enough to facilitate clear understanding of the present invention. In FIG. 20, the processes are identical to those of FIG. 12 except that the “position information extracting process” of the step S310 of FIG. 12 is replaced with the position and date and time information extracting process S310′. For example, a technology disclosed in Japanese Unexamined Patent Publication No. 2001-134600 can be used.

At step 310′, similar to step S310, the text containing the text retrieval result is analyzed to extract information relating to date and time to store in the “date and time information table” in the retrieval history DB 104 as date and time attribute information of the retrieval history data. When the data and time information extracted at this time contains the relevant period or relevant date and time, a flag indicating whether the corresponding text information is valid or not, is added. For example, when the corresponding text is business guide of the shop, possible expression may be that “shop hour” is “from 10:00 to 17:00” and “shop holiday” is “Wednesday”. At this time, since the former information is in effect during the extracted period, “valid” flag is set for the former and “null” flag is set for the latter. On the other hand, not only the time, a special event period, such as “campaign period” and so forth, may also be stored.

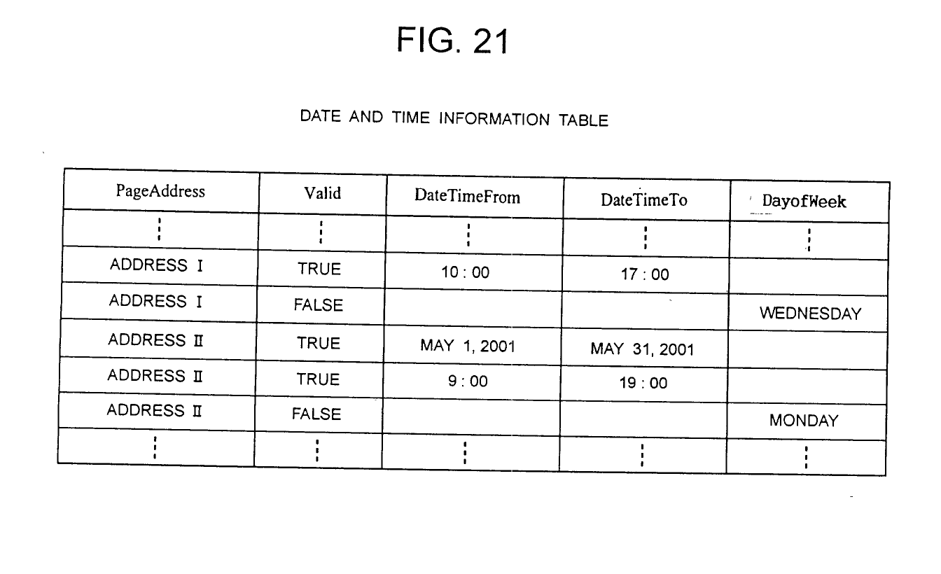

FIG. 21 shows one example of “date and time information table” storing date and time information as set forth above. By a field of “Valid”, the date and time information is indicated as valid or null and indicates the period of the date and time information by “DateTimeFrom” and “DateTimeTo”. On the other hand, information of day of week and so forth is indicated by “Dayofweek”. It is not always required to fill up all fields. For example, in case of one day event, only “DateTimeFrom” is described.

The history retrieval step S304 using the date and time information table takes the date and time information of the date and time information table in the retrieval history data stored in the retrieval history DB 104 as object, and outputs pages having the flag set “Valid” among those matching the condition with the date and time at the timing where the retrieval demand is issued. In this case, the condition relating to “place” is used in addition (step S310′). However, even when the condition relating to the place is not used in addition, the present invention is equally applicable as a matter of course. On the other hand, in the flowchart of FIG. 20, after performing history retrieval at step S304, text retrieval is performed at step S308. In the alternative, the text retrieval may be performed in advance to history retrieval.

When both of position information and date and time information are used, the history retrieval result relating to the date and time and place where the user issues the retrieval demand is displayed on the screen together with the new text retrieval result. On the other hand, if a page among the pages (addresses) in the list of the new text retrieval result, which matches with the past text retrieval result contained in the history retrieval result is present, valid information of the date and time of the content of the page and matching information of the place may be displaced as so-called icons as “current date and time matching information” or “current position relating information”.

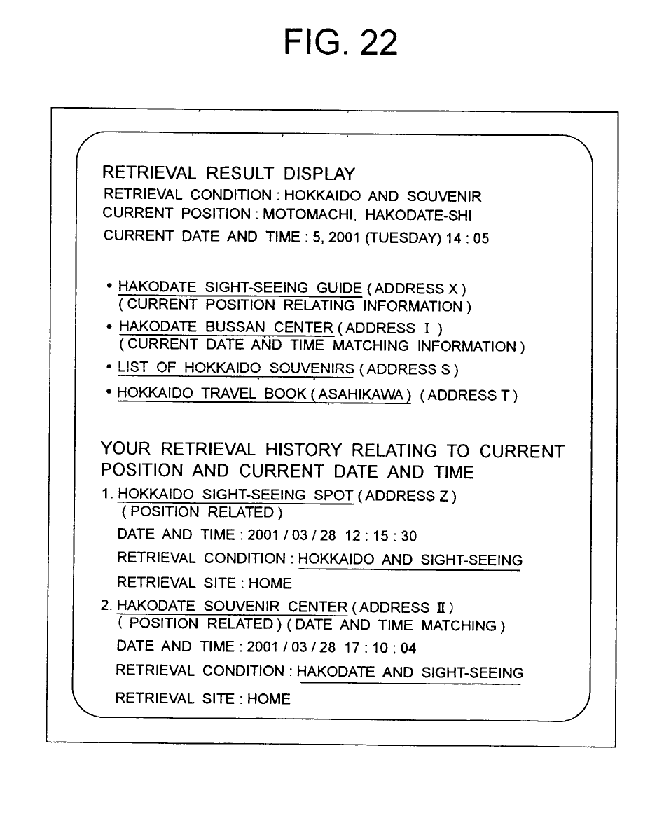

FIG. 22 shows one example of the display screen of the retrieval result in this case. In the shown screen image, the list of the text retrieval result currently designated by the user is displayed in the upper portion, and a list of the information in the past retrieval history matching the condition with the current position and the current date and time information is displayed in the lower portion. In addition, for those containing information relating to the current position or the current date and time among the text retrieval result currently designated, display “current position relating information” or “current date and time matching information” is made for indication thereof. Furthermore, concerning display of the retrieval history, which of the place or date and time is matched, is indicated by icon of “position related” or “date and time matching”. On the other hand, among the text retrieval result currently designated, those having information relating to the current position or the current date and time are registered as retrieval history and are displayed as the retrieval history for matching the condition with the current position or the current date or time. It should be noted that, in the embodiment shown in FIG. 22, while “AddressX” and “AddressI” are not displayed as the retrieval history, these are not displayed in relation to preferential order of the addresses there of, or are displayed in the lower portion which come to be visible by scrolling down.

In respective of foregoing embodiment, when a list of the history retrieval result obtained as a result of history retrieval is to be displayed on the user terminal, there is a method to display with giving the highest preference to the latest information or a method for preferential display for the past accessed information. In the former case, sorting is made by using date and time information. The later method is realized by generating a list whether the user accesses the information or not.

On the other hand, the operation of the foregoing information provider server and the user terminal maybe realized by preliminarily recording the operational procedure as program on a storage medium, such as ROM or the like and by loading the program on the computer.

As set forth above, according to the present invention, the history of information retrieval made by the user is stored to together with the retrieval condition, retrieval demanded site, date and time and the retrieval result, and to extract information relating to the side among the retrieval result to store in association with the retrieval result. Thus, when the user performs retrieval process later, similar past retrieval history can be taken out with taking the information of the position of the ser, the retrieval condition, the retrieval result as key. By this, the information relating to past retrieval and access made by user can be effectively provided.

Particularly, in the mobile environment, among information retrieved and accessed at the office or home, the information relating to the current position can be simply obtained by the user. Thus, information retrieval and obtaining environment at the office or home or under mobile environment can be efficiently cooperated.

Although the present invention has been illustrated and described with respect to exemplary embodiment thereof, it should be understood by those skilled in the art that the foregoing and various other changes, omission and additions may be made therein and thereto, without departing from the spirit and scope of the present invention. Therefore, the present invention should not be understood as limited to the specific embodiment set out above but to include all possible embodiments which can be embodied within a scope encompassed and equivalent thereof with respect to the feature set out in the appended claims.

What is claimed is:

1. An information providing method providing information to a user by issuing retrieval demand to an information providing apparatus from a user terminal through a network, comprising the steps of:
in said information providing apparatus, storing at least a user ID, a past retrieval condition, a past information retrieval result as a retrieval history information relating to a past retrieval demand from said user terminal;
in said user terminal, transmitting a retrieval demand including said retrieval condition to said information providing apparatus;
in said information providing apparatus, receiving said retrieval demand and performing information retrieval according to the retrieval condition contained in said retrieval demand to obtain information retrieval result;
performing history retrieval of the stored retrieval history information according to said user ID of said user terminals and said retrieval condition contained in said retrieval demand;
transmitting retrieval result information contained in the past information retrieval result contained in said retrieval history information and said information retrieval result to said user terminal; and
in said user terminal, receiving and displaying said retrieval result information.

2. An information providing method for issuing retrieval demand to an information providing apparatus from a user terminal through a network and providing information to a user, comprising the steps of:
in said information providing apparatus, storing at least a user ID, a past retrieval condition, a past information retrieval result as a retrieval history information relating to a past retrieval demand from said user terminal;
in said user terminal, transmitting a retrieval demand including said retrieval condition to said information providing apparatus;
in said information providing apparatus, receiving said retrieval demand and performing information retrieval according to the retrieval condition contained in said retrieval demand to obtain information retrieval result;
performing history retrieval of the stored retrieval history information according to said user ID of said user terminals and said information retrieval result obtained through information retrieval for obtaining the corresponding retrieval history information;
transmitting retrieval result information contained in the past information retrieval result contained in said retrieval history information and said information retrieval result to said user terminal; and
in said user terminal, receiving and displaying said retrieval result information.

3. An information providing method for issuing retrieval demand to an information providing apparatus from a user terminal through a network and providing information to a user, comprising the steps of:
in said information providing apparatus, storing at least a user ID and a past information retrieval result as a retrieval history information relating to a past retrieval demand from said user terminal and extracting position information relating to said past information retrieval result for storing with correspondence to said past information retrieval result;
in said user terminal, transmitting a retrieval demand including said retrieval condition and place information indicative of a current position to said information providing apparatus;
in said information providing apparatus, obtaining information retrieval result by information retrieval according to said retrieval condition contained in said received retrieval demand;
performing history retrieval of said retrieval history information stored according to said user ID of said user terminal and said place information contained in said retrieval demand, and obtaining said retrieval history information containing said position information matching with user ID and corresponding to said place information;
transmitting retrieval result information contained in the past information retrieval result contained in said retrieval history information and said information retrieval result to said user terminal; and
in said user terminal, receiving and displaying said retrieval result information.

4. An information providing method for issuing retrieval demand to an information providing apparatus from a user terminal through a network and providing information to a user, comprising the steps of:
in said information providing apparatus, storing at least a user ID and a past information retrieval result as a retrieval history information relating to a past retrieval demand from said user terminal and extracting date and time information relating to said past information retrieval result for storing with correspondence to said past information retrieval result;
in said user terminal, transmitting a retrieval demand including said retrieval condition;
in said information providing apparatus, obtaining information retrieval result by information retrieval according to said retrieval condition contained in said received retrieval demand;
performing history retrieval of said retrieval history information stored according to said user ID of said user terminal and said date and time information contained in said retrieval demand, and obtaining said retrieval history information containing said date and time information matching with user ID and corresponding to said date and time information;
transmitting retrieval result information contained in the past information retrieval result contained in said retrieval history information and said information retrieval result to said user terminal; and
in said user terminal, receiving and displaying said retrieval result information.

5. An information providing apparatus comprising:
storage means for storing at least a user ID, a past retrieval condition, a past information retrieval result as retrieval history information relating to a past retrieval demand from a user terminal;
retrieval control means for receiving a retrieval demand from said user terminal, requesting information retrieval using said retrieval condition contained in said retrieval demand to information retrieving means for performing information retrieval according to the retrieval condition, receiving information retrieval result, and registering the information retrieval result in said storage means together with said retrieval condition, said user ID of said user terminal; and
history retrieval means for performing history retrieval of said retrieval history information stored in said storage means according to said user ID of said user terminal and said retrieval condition contained in said retrieval demand.

6. An information providing apparatus as set forth in claim 5, wherein said storage means has a text retrieval information table storing at least said user ID, past retrieval demand ID, said past retrieval condition and said past information retrieval result with correspondence of text retrieval information,
said retrieval control means generates a retrieval demand ID upon receipt of the retrieval demand and registers said information retrieval result of said information retrieval means, the user ID of said user terminal and said retrieval result contained in said retrieval demand in said text retrieval information table with correspondence to said retrieval demand ID,
said history retrieval means generates a history retrieval information table storing at least said retrieval demand ID, and said past retrieval demand ID contained in said test retrieval information with correspondence there between as history retrieval information, and storing said history retrieval information table in said storage means, when the corresponding text retrieval information is present as a result of history retrieval of said text retrieval information table according to said user ID of said user terminal and said retrieval condition containing in said retrieval demand, and
said text retrieval information is obtained from said text retrieval information table using said retrieval demand ID, said corresponding past information retrieval result is obtained from said history retrieval information table and said text retrieval information table using said retrieval demand ID and has display generation means for generating display screen information using the text retrieval information and the past information retrieval result.

7. An information providing apparatus providing information to a user by issuing a retrieval demand from a user terminal through a network, comprising:
storage means for storing at least a user ID, a past retrieval condition, a past information retrieval result as retrieval history information relating to a past retrieval demand from a user terminal;
retrieval control means for receiving a retrieval demand from said user terminal, requesting information retrieval using said retrieval condition contained in said retrieval demand to information retrieving means for performing information retrieval according to the retrieval condition, receiving information retrieval result, and registering the information retrieval result in said storage means together with said retrieval condition, said user ID of said user terminal; and
history retrieval means for performing history retrieval of said retrieval history information stored in said storage means according to said user ID of said user terminal and said information retrieval result obtained by said information retrieval.

8. An information providing apparatus as set forth in claim 7, wherein said storage means has a text retrieval information table storing at least said user ID, past retrieval demand ID, said past retrieval condition and said past information retrieval result with correspondence of text retrieval information,
said retrieval control means generates a retrieval demand ID upon receipt of the retrieval demand and registers said information retrieval result of said information retrieval means, the user ID of said user terminal and said retrieval result contained in said retrieval demand in said text retrieval information table with correspondence to said retrieval demand ID,
said history retrieval means generates a history retrieval information table storing at least said retrieval demand ID, and said past retrieval demand ID contained in said test retrieval information with correspondence there between as history retrieval information, and storing said history retrieval information table in said storage means, when the corresponding text retrieval information is present as a result of history retrieval of said text retrieval information table according to said user ID of said user terminal and the information retrieval result obtained from said information retrieval, and
said apparatus further comprises display generating means for obtaining said text retrieval information from said text retrieval information table using said retrieval demand ID, obtaining said corresponding past information retrieval result from said history retrieval information table and said text retrieval information table using said retrieval demand ID and generating display screen information using the text retrieval information and the past information retrieval result.

9. An information providing apparatus comprising:
storage means for storing at least a user ID, a past retrieval condition and a past information retrieval result with correspondence therebetween and storing position information relating to said past information retrieval result with correspondence to the past information retrieval result;
retrieval control means for receiving a retrieval demand containing a retrieval condition and a place information indicative of a current position from said user terminal, requesting information retrieval to information retrieval means for performing information retrieval according to said retrieval condition, using said retrieval condition contained in said retrieval demand, receiving information retrieval result, and registering the information retrieval result in said storage means together with said retrieval condition, said user ID of said user terminal; and
history retrieval means for performing history retrieval of said retrieval history information stored in said storage means according to said user ID of said user terminal and said place information contained in said retrieval demand, for obtaining said retrieval history information matching said user ID and containing position information corresponding to said place information.

10. An information providing apparatus as set forth in claim 13, which further comprises position extracting means for extracting position information associated with said information retrieval result using said information retrieval result registered in said storage means by said retrieval control means and registering said position information in said storage means with correspondence to said information retrieval result.

11. An information providing apparatus as set forth in claim 13, wherein said storage means has a text retrieval information table storing at least said user ID, past retrieval demand ID, said past retrieval condition and said past information retrieval result with correspondence of text retrieval information and a position information table storing the position information relating to said past information retrieval result with correspondence to said past information retrieval result,
said retrieval control means generates a retrieval demand ID upon receipt of the retrieval demand and registers said information retrieval result of said information retrieval means, the user ID of said user terminal and said information retrieval result in said text retrieval information table with correspondence to said retrieval demand ID,
said position information extracting means extracts said position information using the registered information retrieval result and registering in said position information table with correspondence to said information retrieval result, and
said history retrieval means performs retrieval on said text retrieval information table and said position information table according to said user ID and said place information contained in said retrieval demand, generates a history retrieval information table storing at least said retrieval demand ID and said past retrieval ID contained in said test retrieval information containing the past information retrieval result with correspondence therebetween as history retrieval information, and storing said history retrieval information table in said storage means, when said user IDs match and the said past information retrieval result containing said position information corresponding to said place information is present, and
said apparatus further comprises display generating means for obtaining said text retrieval information from said text retrieval information table using said retrieval demand ID, obtaining said corresponding past information retrieval result from said history retrieval information table and said text retrieval information table using said retrieval demand ID and generating display screen information using the text retrieval information and the past information retrieval result.

12. An information providing apparatus comprising:
storage means for storing at least a user ID, a past retrieval condition and a past information retrieval result with correspondence therebetween and storing date and time information relating to said past information retrieval result with correspondence to the past information retrieval result;
retrieval control means for receiving a retrieval demand containing a retrieval condition and a place information indicative of a current position from said user terminal, requesting information retrieval to information retrieval means for performing information retrieval according to said retrieval condition, using said retrieval condition contained in said retrieval demand, receiving information retrieval result, and registering the information retrieval result in said storage means together with said retrieval condition, said user ID of said user terminal; and
history retrieval means for performing history retrieval of said retrieval history information stored in said storage means according to said user ID of said user terminal and information of date and time, on which said retrieval demand is issued, for obtaining said retrieval history information matching said user ID and containing date and time information matching the condition with the information of date and time, on which said retrieval demand is issued.

13. An information providing apparatus as set forth in claim 12, which further comprises date and time extracting means for extracting date and time information associated with said information retrieval result using said information retrieval result registered in said storage means by said retrieval control means and registering said date and time information in said storage means with correspondence to said information retrieval result.

14. An information providing apparatus as set forth in claim 12, wherein said storage means has a text retrieval information table storing at least said user ID, the retrieval demand ID and said past information retrieval result with correspondence of text retrieval information and a date and time information table storing the date and time information relating to said past information retrieval result with correspondence to said past information retrieval result,
said retrieval control means generates a retrieval demand ID upon receipt of the retrieval demand and registers said information retrieval result of said information retrieval means, the user ID of said user terminal and said information retrieval result in said text retrieval information table with correspondence to said retrieval demand ID,
said date and time information extracting means extracts said date and time information using the registered information retrieval result and registering in said date and time information table with correspondence to said information retrieval result, and
said history retrieval means performs retrieval on said text retrieval information table and said date and time information table according to said user ID and said information of dare and time, on which said retrieval demand is issued, generates a history retrieval information table storing at least said retrieval demand ID and said past retrieval ID contained in said text retrieval information containing the past information retrieval result with correspondence therebetween as history retrieval information, and storing said history retrieval information table in said storage means, when said user IDs match and said past information retrieval result containing said date and time information matching the condition with the information relating to the date and time, on which the retrieval demand is issued, is present, and
said apparatus further comprises display generating means for obtaining said text retrieval information from said text retrieval information table using said retrieval demand ID, obtaining said corresponding past information retrieval result from said history retrieval information table and said text retrieval information table using said retrieval demand ID and generating display screen information using the text retrieval information and the past information retrieval result.

15. A user terminal receiving information by issuing a retrieval demand to an information providing apparatus through a network, comprising:
means for making said information providing means to store at least a user ID, a past retrieval condition and a past information retrieval result with correspondence therebetween as a retrieval history relating to the past retrieval demand from said user terminal;
means for transmitting the retrieval demand including said retrieval condition to said information providing apparatus;
means for commanding operation of said information providing apparatus for obtaining information retrieval result through information retrieval according to said retrieval condition contained in said retrieval demand, performing history retrieval of said retrieval history information storing according to said user ID and said retrieval condition contained in said retrieval demand for obtaining said corresponding retrieval history information and transmitting the retrieval result information containing said past information retrieval result contained in said retrieval history information and said information retrieval result; and
means for receiving said retrieval result information and display the same.

16. A user terminal receiving information by issuing a retrieval demand to an information providing apparatus through a network, comprising:
means for making said information providing means to store at least a user ID, a past retrieval condition and a past information retrieval result with correspondence therebetween as a retrieval history relating to the past retrieval demand from said user terminal;
means for transmitting the retrieval demand including said retrieval condition to said information providing apparatus;
means for commanding operation of said information providing apparatus for obtaining information retrieval result through information retrieval according to said retrieval condition contained in said retrieval demand, performing history retrieval of said retrieval history information storing according to said user ID and said information retrieval result obtained by performing information retrieval for obtaining said corresponding retrieval history information and transmitting the retrieval result information containing said past information retrieval result contained in said retrieval history information and said information retrieval result; and
means for receiving said retrieval result information and display the same.

17. A user terminal receiving information by issuing a retrieval demand to an information providing apparatus through a network, comprising:
means for making said information providing means to store at least a user ID and a past information retrieval result with correspondence therebetween as a retrieval history relating to the past retrieval demand from said user terminal, and extracting a position information relating to said past information retrieval result to store said position information with correspondence with said past information retrieval result;
means for transmitting the retrieval demand including said retrieval condition and a place information indicative of a current position to said information providing apparatus;
means for commanding operation of said information providing apparatus for obtaining information retrieval result through information retrieval according to said retrieval condition contained in said retrieval demand, performing history retrieval of said retrieval history information storing according to said user ID and said place information contained in said retrieval demand for obtaining said corresponding retrieval history information where the user IDs match and containing position information corresponding to said place information and transmitting the retrieval result information containing said past information retrieval result contained in said retrieval history information and said information retrieval result; and
means for receiving said retrieval result information and display the same.

18. A user terminal receiving information by issuing a retrieval demand to an information providing apparatus through a network, comprising:
means for making said information providing means to store at least a user ID and a past information retrieval result with correspondence therebetween as a retrieval history relating to the past retrieval demand from said user terminal, and extracting a date and time information relating to said past information retrieval result to store said position information with correspondence with said past information retrieval result;
means for transmitting the retrieval demand including said retrieval condition to said information providing apparatus;
means for commanding operation of said information providing apparatus for obtaining information retrieval result through information retrieval according to said retrieval condition contained in said retrieval demand, performing history retrieval of said retrieval history information storing according to said user ID and information relating to date and time, on which said retrieval demand is issued for obtaining said corresponding retrieval history information where the user IDs match and containing date and time information corresponding to said place information and transmitting the retrieval result information containing said past information retrieval result contained in said retrieval history information and said information retrieval result; and
means for receiving said retrieval result information and display the same.
